(19) United States
(12) Patent Application Publication
(10) Pub. No.: US 2025/0058283 A1
(43) Pub. Date: Feb. 20, 2025

(54) BAFFLE FOR A MEMBRANE DEVICE

(71) Applicant: EVOVE LTD, Manchester (GB)

(72) Inventors: Claire ASHWORTH, Manchester (GB); Kangsheng BRETHERTON-LIU, Manchester (GB); Omkar JOSHI, Manchester (GB); Tristan PHILLIPS, Manchester (GB); Thomas PUGH, Manchester (GB)

(21) Appl. No.: 18/720,850

(22) PCT Filed: Dec. 16, 2022
(86) PCT No.: PCT/GB2022/053269

§ 371 Date: Jun. 17, 2024

(30) Foreign Application Priority Data
Dec. 17, 2021 (GB) 2118427.0

(51) Int. Cl. B01D 65/08; B01D 63/06; B01D 69/02; B01D 69/04

(52) U.S. Cl. CPC B01D 65/08; B01D 63/06; B01D 69/02; B01D 69/04; B01D 2321/2016; B01D 2325/02; B01D 2325/24; B01D 2325/36

(57) ABSTRACT

A baffle for a membrane device. The membrane device includes a membrane, a feed flow inlet, and a feed flow outlet, such as for water filtration. The baffle includes a proximal end and a distal end, wherein the baffle is operable to extend along at least a portion of the membrane so that the proximal end is toward the feed flow inlet of the membrane device and the distal end is toward the feed outlet of the membrane device. The baffle includes a first geometry portion and a second geometry portion. The first geometry portion includes a higher aspect ratio than the second geometry portion and the first geometry portion is arranged closer to the proximal end of the baffle than the second geometry portion. Also described is a method of producing the baffle and a membrane device containing the baffle.

### FIELD

The present invention relates to a baffle for a membrane device. More specifically, the present invention relates to a baffle for tubular membranes, suitably for water treatment.

### BACKGROUND

Conventional methods of water treatment such as chemical disinfection, solar disinfection, boiling, sedimentation and distillation are not sufficient to meet the portable water requirement of the world's population at low cost. In order to tackle the problem, more advanced technologies have been established and industrialised, such as pressure driven membrane-based water treatment technologies which in general include ultrafiltration (UF), microfiltration (MF), nanofiltration (NF), and reverse osmosis (RO). By providing the advantages of circumventing the application of thermal inputs, chemical additives and reducing medium regeneration, these methods have significantly improved the water treatment industry.

Membrane filtration is favoured over other water treatment technologies due to, in principle, no significant thermal input, fewer chemical additives and a lower requirement for the regeneration of spent media. Pressure-driven membrane processes are the most widely applied membrane technologies in water treatment, for the removal of particulates, ions, microorganisms, bacteria, and natural organic materials, covering different applications from waste treatment from the food and oil industry to seawater desalination.

However, when using current membrane systems for water treatment, a layer of particles in high concentration forms adjacent to the membrane surface, which creates resistance for the water to permeate through the membrane. Over time, the concentration in this layer increases, which further increases resistance to the water permeating through the membrane thereby causing a reduction in the flux over time. Furthermore, the ongoing flux continually increases the concentration of particles near the membrane. After a while, the concentration of particles at the membrane surface becomes high enough that there is a steep concentration gradient in the vicinity of the membrane surface. This results in diffusion of particles from the membrane surface to the bulk feed flow. Eventually, an equilibrium is reached between the rate of transport of particles due to convection (from bulk feed flow to membrane surface) and diffusion (from membrane surface to the bulk feed flow), thus flux stabilizes, although at a level significantly lower than the initial flux. This phenomenon is known as concentration polarization (CP) and the region of high concentration adjacent to the membrane is called a concentration polarization (CP) layer. While a CP layer is typically reversible and only exists when flow has been established, over time it can become compact and begin to irreversibly foul the membrane, affecting flux even further.

To reduce the effect of concentration polarization, a baffle can be installed in the membrane system. When employing the use of a baffle, the velocities near the membrane surface are higher compared to a membrane without the use of such baffle. This creates high shear on the membrane surface that aids in removing any deposits of particles on the membrane surface and also reduces the thickness of the concentration polarisation layer, resulting in an overall higher flux.

However, current baffles used with membranes are found to produce a considerable pressure drop along the length of the membrane, resulting in uneven flux through the length of the membrane.

The drive to produce new clean water resources and protect existing water resources at lower capital and operating costs demands improved and tuneable fouling resistance, higher yield at lower energy inputs, longer life span and improved chemical and mechanical resistance.

Accordingly, improved membrane systems and processing technologies for efficient water treatment having properties to fulfil the demands are desired.

It is therefore an object of aspects of the present invention to address one or a few of the problems mentioned above or other problems.

### SUMMARY

According to a first aspect of the present invention, there is provided a baffle for a membrane device comprising a membrane, a feed flow inlet, and a feed flow outlet, such as for water filtration,
wherein the baffle comprises a proximal end and a distal end, wherein the baffle is operable to extend along at least a portion of the membrane so that the proximal end is toward the feed flow inlet of the membrane device and the distal end is toward the feed outlet of the membrane device,
and wherein the baffle comprises a first geometry portion and a second geometry portion, wherein the first geometry portion comprises a higher aspect ratio than the second geometry portion and wherein the first geometry portion is arranged closer to the proximal end of the baffle than the second geometry portion.

According to a second aspect of the present invention, there is provided a baffle, suitably a baffle according to the first aspect of the present invention, wherein the baffle is prepared by a method comprising:
a. producing the baffle by additive manufacturing.

According to a third aspect of the present invention, there is provided a method of preparing a baffle, suitably a baffle according to the first or second aspect of the present invention, the method comprising:
a. producing the baffle by additive manufacturing.

According to a fourth aspect of the present invention, there is provided a membrane device comprising a membrane, a feed flow inlet, a feed flow outlet, and a baffle according to any of the first to the third aspects of the present invention, wherein the baffle extends along at least a portion of the membrane so that the proximal end is toward the feed flow inlet of the membrane device and the distal end is toward the feed outlet of the membrane device.

According to a fifth aspect of the present invention, there is provided a kit of parts for a membrane device comprising a membrane and a baffle according to any of the first to the third aspects of the present invention.

According to a sixth aspect of the present invention, there is provided a method of separating a component from a feed flow composition, comprising:
a. introducing a feed flow composition into a membrane device according to the fourth aspect of the present invention so that the feed flow contacts the baffle;
b. effecting separation of at least a portion of the component from the feed flow through the membrane of the membrane device into a permeate composition.

According to a seventh aspect of the present invention, there is provided a water treatment module comprising a membrane device according to the fourth aspect of the present invention.

According to an eighth aspect of the present invention, there is provided a water treatment device comprising a water treatment module according to the seventh aspect of the present invention.

Advantageously, employing a baffle according to any of the first to eighth aspects of the present invention, wherein the first portion has a higher aspect ratio than the second portion, and wherein the first portion is arranged closer to the proximal end of the baffle than the second portion, the cross-flow velocities (and hence shear on the membrane) of the feed may be enhanced towards the distal end of the membrane. This shear on the membrane surface may improve the flux towards the distal end of the membrane, compensating for the depleted transmembrane pressure in this region and thus may produce a more uniform flux through the length of the membrane. Moreover, the increased cross-flow velocity towards the distal end of the membrane may also remove the particles near the membrane surface more effectively, thus this region is less likely to be fouled, which is especially advantageous when considering that this region will intrinsically have lower pressure.

The use of a baffle according to the present invention may also result in a smaller pressure drop across the membrane compared to a baffle with uniform design parameters through the length of the membrane for the same amount of flux and feed flow rate.

Advantageously, the baffle according to the present invention may require lower energy per unit volume of the permeate produced, known as specific energy consumption (or SEC), compared to that required with a baffle with a uniform aspect ratio through the length of the membrane.

Such baffles have a driving geometric parameter which enhances the cross-flow velocities (and hence the shear) at the membrane surface. Because the sizes of the membranes vary between the manufacturers and the types of application, this geometric parameter can be normalised with the diameter of the membrane to obtain a dimensionless term “aspect ratio”. It has been found that reducing the aspect ratio increases the degree of enhancement in the cross-flow velocities and the resulting improved shear at the surface of the membrane may hydrodynamically reduce the concentration of the accumulated particles near the membrane surface to reduce the severity of CP and fouling, and thus improve flux.

Current commercially available baffles used with membranes have a uniform aspect ratio along the length of the membrane and they produce a considerable pressure drop along the length of the membrane. The proximal end of the membrane experiences a higher pressure compared to the distal end of the membrane, however, the cross-flow velocities do not change through the length of the membrane. Accordingly, because flux increases with an increase in transmembrane pressure, the overall effect of the pressure gradient which is formed results in uneven flux through the length of the membrane, with the distal most end of the membrane experiencing lower flux. Employing a baffle with a uniform small aspect ratio through the length of the membrane may enhance the cross-flow velocities towards the distal end of the membrane, but also may increase the pressure drop even further.

In the present invention, the baffle may be adapted for different applications and apparatus by introducing variability in the aspect ratio. If the aspect ratio is gradually reduced from the proximal end to the distal end, the cross-flow velocities may be gradually enhanced towards the distal end. The enhanced cross-flow velocities may compensate for the depleted transmembrane pressure in this region, thus achieving a more uniform flux through the length of the membrane.

The baffle may be operable to affect the flow of fluid in the membrane device, such as to change the direction and/or velocity of the fluid flow upon contact of the fluid with the baffle. The baffle may be operable to increase the shear at the membrane surface by enhancing the cross-flow velocity near the membrane surface.

The first and second geometry portions may be operable to affect the cross-flow velocity at the membrane surface.

The second geometry portion of the baffle, comprising a lower aspect ratio than the first geometry portion, may be operable to produce a larger cross-flow velocity than the first geometry portion of the baffle.

The baffle may comprise any suitable geometry. The geometry portions of the baffle may independently comprise a geometry having a substantially continuously changing lateral dimension, such as diameter, along the longitudinal length of the geometry portion, such as a substantially continuously decreasing lateral dimension from the proximal end of the geometry portion to the distal end of the geometry portion; and/or comprise a geometry having a varied lateral dimension along the longitudinal length of the geometry portion.

A geometry portion having a varied lateral dimension along its longitudinal length may comprise at least two geometry elements, such as comprise repeating geometry elements of substantially similar shape. As used herein, of ‘substantially similar shape’ may mean that the repeating elements are substantially of the same shape except for a change in the length of a dimension, such as a change in the length of the longitudinal dimension.

A geometry portion and/or repeating geometry element may comprise helical contours and/or alternate converging and diverging contours.

A geometry portion, such as a geometry portion having a substantially continuously changing lateral dimension, may comprise a tapered geometry, such as a conical geometry.

As used herein, the ‘aspect ratio’ may be defined as ‘the distance between the starting points of the adjacent baffle elements as measured along the longitudinal axis of the baffle to the diameter of the membrane at the transverse plane of the starting point of the geometry portion’ or ‘the ratio of the gap between the geometry portion and the membrane surface (e.g. an annular gap) to the diameter of the membrane at the transverse plane of the geometry portion’.

The first geometry portion may comprise an aspect ratio of at least 0.2, such as at least 0.3. The first geometry portion may comprise an aspect ratio of up to 12, such as up to 10. The first geometry portion may comprise an aspect ratio of from 0.2 to 10, such as from 0.3 to 10.

The second geometry portion may comprise an aspect ratio of at least 0.05, such as at least 0.1. The second geometry portion may comprise an aspect ratio of up to 11, such as up to 9. The second geometry portion may comprise an aspect ratio of from 0.05 to 11, such as from 0.1 to 9.

When a geometry portion comprises geometry elements the aspect ratio may be defined as the ratio of the distance between the starting points of the adjacent baffle elements as measured along the longitudinal axis of the baffle to the diameter of the membrane at the transverse plane of the starting point of the geometry portion.

When the first geometry portion comprises geometry elements, the aspect ratio may be at least 1. When the first geometry portion comprises geometry elements, the aspect ratio may be up to 10. When the first geometry portion comprises geometry elements, the aspect ratio may be from 1 to 10.

When the second geometry portion comprises geometry elements, the aspect ratio may be at least 0.5. When the second geometry portion comprises geometry elements, the aspect ratio may be up to 9. When the second geometry portion comprises geometry elements, the aspect ratio may be from 0.5 to 9.

When a geometry portion comprises a geometry having a substantially continuously changing lateral dimension, e.g. a conical geometry, the aspect ratio may be defined as the ratio of the gap between the geometry portion and the membrane surface (e.g. an annular gap) to the diameter of the membrane at the transverse plane of the geometry portion.

When the first geometry portion comprises a geometry having a substantially continuously changing lateral dimension the aspect ratio may be at least 0.3. When the first geometry portion comprises a geometry having a substantially continuously changing lateral dimension the aspect ratio may be up to 0.9. When the first geometry portion comprises a geometry having a substantially continuously changing lateral dimension the aspect ratio may be from 0.3 to 0.9.

When the second geometry portion comprises a geometry having a substantially continuously changing lateral dimension the aspect ratio may be at least 0.1. When the second geometry portion comprises a geometry having a substantially continuously changing lateral dimension the aspect ratio may be up to 0.6. When the second geometry portion comprises a geometry having a substantially continuously changing lateral dimension the aspect ratio may be from 0.1 to 0.6

The aspect ratio may vary along the longitudinal length of the baffle and/or geometry portion according to the gradient, such as along a linear gradient, along an exponential gradient and/or along a polynomial gradient. The aspect ratio of the baffle may decrease from the proximal end of the baffle to the distal end of the baffle. Advantageously, this arrangement may establish a gradient in the cross-flow velocities in the membrane such that the cross-flow velocities at the distal end are enhanced and the resulting high shear helps improve flux in this region, compensating for the depleted transmembrane pressure and producing a more uniform flux.

Preferably, the first and/or second geometry portion comprises helical contours. Helical contours increase the average length of the path the feed flow travels in the membrane without introducing too many perturbations and flow separation. This is because the contours may guide the flow towards the outlet and hence not only the cross-flow velocities are amplified but also the surface of the membrane may be better utilised.

The first and second geometry portions and/or the geometry elements may be abutting, such as integrally formed.

The baffle may comprise a spacer portion arranged between and spacing adjacent geometry portions, such as between the first and second geometry portions, and/or between geometry elements. The spacer portion may be substantially free of geometries that are operable to significantly affect the cross-flow velocity at the membrane surface, at least relative to the geometry portions. The baffle may comprise at least one spacer portion, such as at least two, such as at least three, such as at least four. Advantageously, the presence of a spacer may reduce the pressure drop while still achieving benefit from the increased cross-flow velocity generated by the geometry portions.

The baffle may comprise sets of first and second geometry portions, each set comprising at least one first and at least one second geometry portion, the geometry portion sets separated by a spacer portion. The baffle may comprise at least two geometry portion sets, such as at least three, or at least four. The aspect ratios of the first and/or second portions may be different across the different sets.

The spacer portion may be of any suitable length. The spacer portion may extend along up to 70% of the total baffle length such as up to 50%, such as up to 30%.

The baffle may comprise a support operable to abut the membrane surface and space the geometry portions from the membrane surface. The support may be substantially free of geometries operable to significantly affect the cross-flow velocity at the membrane surface, at least relative to the geometry portions. The baffle may comprise at least one spacer portion, such as at least two, such as at least three, such as at least four.

The baffle may comprise a support extending radially from the baffle. The baffle may comprise at least two supports extending radially from the baffle along substantially the same lateral plane, such as at least three. The baffle may comprise three substantially evenly spaced radially extending supports on the same lateral plane.

The baffle may have any suitable length such as up to 400 cm, such as up to 80 cm, such as up to 10 cm.

The baffle may be prepared by any suitable manufacturing process, such as additive manufacturing or injection moulding. Preferably, the baffle is prepared by additive manufacturing.

The additive manufacturing technique may be any suitable 3D printing technology. For example, the baffle according to any aspect of the present invention may be printed using a vat photopolymerization, such as stereolithography (SLA); digital light processing; two-photon polymerisation; two colour photo-polymerisation; inkjet printing; binder jet printing; direct ink writing; three-dimensional printing; selective laser sintering; selective laser melting; laminated object manufacturing, and/or fused deposition modelling.

Preferably, the baffle according to any aspect of the present invention is prepared by additive manufacturing using a vat photopolymerization, such as SLA.

The baffle may comprise any suitable material. The baffle may comprise a polymeric material, a ceramic material, a composite material, an inorganic-organic material and/or a metal material.

The baffle according to any aspect of the present invention may be formed from materials selected from UV cured thermoset precursor materials; polycarbonate based materials such as Accura 5530, Accura 60, Accura 55; acrylonitrile butadiene styrene based materials such as Renshape SL7820, Somos Watershed XC 11122, Accura Xtreme White 200, Somos 14120; polypropylene based materials such as Somos 9120, Acurra 25, Samos NeXT; polyethylene based materials such as VisiJet SL Flex; epoxy based materials such as Epoxy SL5170; acrylic based materials such as Accura Xtreme, Accura Xtreme 200 or any combination thereof.

Advantageously, the baffle may be produced with improved ease of processing and/or low cost.

The membrane may comprise a substrate.

The membrane may comprise a polymeric substrate, a polymeric substrate containing inorganic filler, a ceramic substrate, a composite substrate, a metal substrate, such as a metal mesh substrate, an inorganic substrate, an inorganic-organic substrate, such as a woven filament such as a woven mono-filament or a woven multi-filament, and/or a non-woven substrate, and/or a casted substrate.

A polymeric porous substrate may be formed from materials selected from polyacrylonitrile (PAN); a polyester such as polyethylene terephthalate (PET), polycarbonate (PC), polyamide (PA), poly(ether) sulfone (PES), polybutylene terephthalate (PBT), polysulfone (PSf), polypropylene (PP), cellulose acetate (CA), poly(piperazine-amide), polyvinylidene difluoride (PVDF), polytetrafluoroethylene (PTFE), chlorinated polyvinyl chloride (CPVC), poly(phthalazinone ether sulfone ketone) (PPESK), polyamide-urea, polyether ether ketone (PEEK), poly(phthalazinone ether ketone); thin film composite porous films (TFC), suitably the TFC comprises an ultra-thin ‘barrier’ layer polymerised in situ over a porous polymeric support membrane, such as commercially available polyamide derived TFCs of an interfacially synthesized polyamide formed over a polysulfone (PSf) membrane, and/or others TFCs such as poly(piperazine-amide)/poly(vinyl-alcohol) (PVA), poly(piperazine-amide)/poly(phthalazinone biphenyl ether sulfone (PPBES), hydrolyzed cellulose tri-acetate (CTA)/cellulose acetate (CA) TFCs.

Preferably the polymeric porous substrate is formed from polyethylene terephthalate.

The membrane may comprise an inorganic-organic porous matrix substrate. The inorganic-organic porous matrix substrate may comprise inorganic particles contained within a porous organic polymeric substrate. An inorganic-organic porous matrix substrate may be selected from zirconia nanoparticles with polysulfone (PSf) porous membrane. Advantageously, an inorganic-organic porous matrix substrate may provide a combination of an easy to manufacture low-cost substrate which has good mechanical strength. An inorganic-organic porous substrate, such as zirconia nanoparticles with polysulfone (PSf) may advantageously provide elevated permeability. Other inorganic-organic porous substrates may be selected from thin film nanocomposite substrates comprising one or more type of inorganic particle; metal-based foam such as aluminium foam, copper foam, lead foam, zirconium foam, stannum foam, and gold foam; mixed matrix substrates comprising inorganic fillers in an organic matrix to form organic-inorganic mixed matrix.

The substrate may be inorganic and may be selected from stainless-steel mesh, copper mesh, alloy mesh, aluminium mesh, such as ceramic substrate, such as alumina substrate, silicon carbide substrate, and/or zirconia substrate, such as titanium oxide substrate, such as zeolite, preferably metal mesh and alumina substrate.

Advantageously, a substrate in the form of a porous polymeric substrate and metal, mesh can provide improved ease in processing and/or low cost.

The membrane may comprise hydrophilic and/or superhydrophilic materials.

The hydrophilic and/or superhydrophilic materials may be incorporated into the membrane substrate materials. As such, the substrate may comprise hydrophilic material. The hydrophilic material may be pre-blended into membrane substrate materials. The hydrophilic material may be incorporated using methods such as phase inversion, extrusion, or interfacial polymerisation.

Advantageously, surface treatment of polymeric substrates may provide improved adhesion and uniformity of the subsequent coating layers applied on the substrate. The presence of said hydrophilicity and/or functionality on the polymeric substrate provides an active layer having a more robust mechanical integrity, a more uniform structure and improved continuity. The said hydrophilicity and/or functionality has also been found to provide improved filter life span and stability. Surface treatment can also improve properties such as enhanced permeability.

The hydrophilic material that may be incorporated in to the substrate may be selected from cellulose acetate, quaternized polyethersulfone, polylactic acid, polyethylenimine, polyetherimide, polyvinylpyrrolidone and/or poly(vinyl alcohol).

The baffle and/or membrane may comprise a coating. The coating may be operable to provide a separation effect. As such, the coating may be operable to selectively promote the passage of some of the material to be separated while reducing the passage of other material.

There is also provided a membrane device comprising a membrane, a feed flow inlet, a feed flow outlet, and a baffle, wherein the baffle extends along at least a portion of the membrane so that a proximal end is toward the feed flow inlet of the membrane device and a distal end is toward the feed outlet of the membrane device, and wherein the baffle and/or membrane comprises a coating arranged on the baffle or a membrane substrate.

The coating may comprise a hydrophilic agent and/or a superhydrophilic agent. The coating may comprise a first coating layer comprising a hydrophilic agent and a second coating layer comprising a superhydrophilic agent. The second coating layer may be arranged over at least a part of the first coating layer.

The coating comprising a superhydrophilic agent may be arranged on the surface of the membrane that faces the feed flow.

The coating may be at least partially crosslinked and comprise a superhydrophilic agent.

The coating may be formed from a coating composition, such as a coating comprising a hydrophilic agent and/or a superhydrophilic agent, and/or being at least partially crosslinked and comprising a superhydrophilic agent may be formed from a coating composition comprising the hydrophilic agent or precursor thereof, when present, and/or the superhydrophilic agent or precursor thereof.

The surface of the baffle/membrane substrate operable to receive a coating may be hydrophilic. The contact angle of water on the substrate surface may be ≤65°, such as ≤60° and preferably ≤55°.

The baffle/membrane substrate may be a pre-treated substrate. The substrate may be treated prior to the addition of the coating formulations. For example, a surface of the substrate may have been subjected to hydrophilisation to form a hydrophilic surface. Said substrate treatment may comprise the addition, suitably the grafting, of functional groups and/or the addition of hydrophilic additives. The added functional groups may be selected from one or more of hydroxyl, ketone, aldehyde, carboxylic acid and amine groups. Preferably hydroxyl or carboxylic acid groups.

The grafting of functional groups may be achieved by plasma treatment, corona discharge, redox reaction, radiation, UV-ozone treatment, and/or chemical treatment. One example of plasma treatment is using an oxygen plasma on the substrate for thirty seconds.

An example of a treated substrate is grafted hydroxyl groups on a polyethersulfone substrate introduced by plasma treatment. The functionalised groups of the substrate may be operable to interact with a functional group of the adjacent coating layer, such as with physical and/or chemical bonding. For example, the said grafted hydroxyl groups may be operable to react with carboxylated hydrophilic cellulosic materials in a coating layer via esterification or react with a siloxane component in an intermediate layer.

Additionally, or alternatively, surface treatment may be achieved by incorporating hydrophilic materials into the substrate materials. As such, the substrate may comprise hydrophilic material.

The hydrophilic material that may be incorporated in to the substrate may comprise cellulose acetate, quaternized polyethersulfone, polylactic acid, polyethylenimine, polyetherimide, polyvinylpyrrolidone and/or poly (vinyl alcohol).

The hydrophilic material may be pre-blended into substrate material. The hydrophilic material may be incorporated using methods such as phase inversion, extrusion and/or interfacial polymerisation.

The substrate may comprise ≥1% hydrophilic material by weight of the substrate, such as ≥5 wt %, or ≥7 wt %. The substrate may comprise ≤50% hydrophilic material by weight of the substrate, such as ≤35 wt %, or ≥ 25 wt %. The substrate may comprise from 1 to 50% hydrophilic material by weight of the substrate, such as from 5 to 35 wt %, or from 7 to 25 wt %.

Advantageously, surface treatment of polymeric substrates may provide improved adhesion and uniformity of the subsequent coating layers applied on the substrate. The presence of said hydrophilicity and/or functionality on the polymeric substrate may provide a coating layer having a more robust mechanical integrity, a more uniform structure and improved continuity. The said hydrophilicity and/or functionality may also provide improved life span and/or stability. Surface treatment can also improve properties such as enhanced permeability.

The hydrophilic agent may be a material having a surface tension that is lower than the surface energy of the substrate.

The hydrophilic agent, and/or coating layer comprising the hydrophilic agent, may have a contact angle of ≤65°, such as ≤60°, or ≤55°, such as ≤50°.

The hydrophilic agent, and/or coating layer comprising the hydrophilic agent, suitably has a higher contact angle than the superhydrophilic agent, or the coating layer comprising the superhydrophilic agent.

The hydrophilic agent or precursor thereof may comprise a (co)polymer or oligomer, such as a polyelectrolyte, polydopamine, and/or polyethylenimine, or precursor thereof. The hydrophilic agent (co)polymer may be branched.

The hydrophilic agent (co)polymer may have a weight average molecular weight (Mw) of at least 5,000 Da, such as at least 10,000 Da or at least 15,000 Da. The hydrophilic agent (co)polymer may have a weight average molecular weight (Mw) of up to 50,000 Da, such as up to 40,000 Da or up to 30,000 Da. The hydrophilic agent (co)polymer may have a weight average molecular weight (Mw) of from 5,000 to 50,000 Da, such as from 10,000 to 40,000 Da or from 15,000 to 30,000 Da.

The hydrophilic agent (co)polymer may be formed from vinylpyrrolidone, vinyl alcohol, allylamine, ethylenimine, allylammonium chloride, vinylamine, lysine, chitosan, silane-based and/or its derivatives; acrylics, such as water soluble acrylics; acrylamide (e.g., copolymers containing 2-acrylamido-2-methylpropane sulfonic acid—AMPS); and/or hydroxyalkylmethacrylate, such as hydroxyethylmethacrylate (e.g. poly HEMA), and copolymers thereof, such as with acrylic acid, methacrylic acid, and/or 2-acrylamido-2-methylpropane sulfonic acid.

The hydrophilic polymer may be a copolymer formed from acrylamide and acrylic acid monomers with polyallylammonium chloride.

The hydrophilic agent may comprise a two-dimensional material and/or a nanoparticle material.

The hydrophilic agent may comprise a graphene-based material, metal organic framework material, silicene, germanene, stanene, boron-nitride, suitably h-boron nitride, carbon nitride, metal-organic nanosheets, molybdenum disulfide, tungsten disulfide, polymer/graphene aerogel, and/or positively charged polymers.

The graphene-based material may comprise graphene oxide, reduced graphene oxide, hydrated graphene, amino-based graphene, alkylamine functionalised graphene oxide, ammonia functionalised graphene oxide, amine functionalised reduced graphene oxide, octadecylamine functionalised reduced graphene oxide, and/or polymer graphene aerogel, preferably graphene oxide.

The hydrophilic agent may have an average platelet size of from 1 nm to 100,000 nm, such as from 10 nm to 50,000 nm, or from 100 nm to 15,000 nm, preferably from 500 nm to 14,000 nm.

The hydrophilic agent may have a platelet size distribution D50 of from 1 nm to 15,000 nm, preferably from 100 nm to 14,000 nm. The graphene-based material may have a platelet size distribution D90 of from 5 nm to 15,000 nm, preferably from 100 nm to 14,000 nm.

The hydrophilic agent may have an oxygen atomic content of from 1% to 70%, such as from 5% to 60%, or from 10% to 50%, preferably from 15% to 55%.

Suitably, the hydrophilic agent, preferably graphene-based material such as graphene oxide, comprises hydroxyl, carboxylic and/or epoxide groups. The oxygen content of the hydrophilic agent, preferably with functional groups of hydroxyl and/or carboxylic groups, may be up to 60% oxygen atomic percentage, such as up to 50% or up to 45% oxygen atomic percentage. Suitably, the oxygen content is from 20 to 25% or from 25 to 45%. Advantageously, when the oxygen content is from 25 to 45% a surfactant may not be required to maintain stability of the coating composition. Preferably, the oxygen content is from 25 to 40% oxygen atomic percentage. Such a range can provide improved stability of the coating composition despite the absence of other stabilising components such as surfactants, and provide enhanced interaction with a primer layer. Oxygen content may be characterised by X-ray photoelectron spectroscopy (XPS), K-Alpha grade, from ThermoFisher Scientific.

The oxygen content of the hydrophilic agent may be up to 50% oxygen atomic percentage.

The oxygen content of the hydrophilic agent may be from 25 to 45%.

The size distribution of the hydrophilic agent may be such that at least 30 wt % of the material has a diameter of between 1 nm to 5,000 nm, such as between 1 to 750 nm, 100 to 500 nm, 100 to 400 nm, 500 to 1000 nm, 1000 to 3000 nm, 1000 to 5000 nm, 1500 to 2500 nm, or 500 to 1500 nm, preferably 100 to 3000 nm, more preferably at least 40 wt %, 50 wt %, 60 wt %, 70 wt % and most preferably at least 80 wt % or at least 90 wt % or 95 wt % or 98 wt % or 99 wt %. The size of the hydrophilic agent and size distribution may be measured using transmission electron microscopy (TEM, JEM-2100F, JEOL Ltd. Japan).

The hydrophilic agent may be in the form of a monolayer or multi-layered particle, preferably a monolayer. The particles of hydrophilic agent may be formed of single, two or few layers of hydrophilic agent, wherein few may be defined as between 3 and 20 layers. Suitably, the hydrophilic agent may comprise from 1 to 15 layers, such as from 2 to 10 layers or 5 to 15 layers. Suitably, at least 30wt % of the hydrophilic agent comprises from 1 to 15 layers, such as from 1 to 10 layers or 5 to 15 layers, more preferably at least 40 wt %, 50 wt %, 60 wt %, 70 wt % and most preferably at least 80 wt % or at least 90 wt % or 95 wt % or 98 wt % or 99 wt %. The number of layers in the hydrophilic agent may be measured using atomic force microscopy (AFM or transmission electron microscopy (TEM)) (TT-AFM, AFM workshop Co., CA, USA).

Suitably, the d-spacing between adjacent lattice planes in the hydrophilic agent or mixture thereof is from 0.34 nm to 5000 nm, such as from 0.34 nm to 1000 nm, or from 0.4to 500 nm, or from 0.4 to 250 nm, such as from 0.4 to 200 nm, or from 0.4 to 150 nm, or from 0.4to 100 nm, or from 0.4 to 50 nm, or from 0.4 to 25 nm, or from 0.4 to 10 nm, or from 0.4 to 8 nm, such as from 0.4 to 7 nm, from 0.45 to 6 nm, 0.50 to 5 nm, or 0.55 to 4 nm, or 0.6 to 3 nm, for example, 0.6 to 2.5 nm, 0.6 to 1 nm, 0.6 to 2 nm, or 0.6 to 1.5 nm.

The water contact angle of the superhydrophilic agent, the coating layer, or coating composition, suitably the water contact angle of the second coating layer comprising the superhydrophilic agent, may be ≤25°, such as ≤20°, such as ≤15°, preferably ≤10°. When used herein, the water contact angle was measured according to ASTM D7334-08.

The water contact angle of the superhydrophilic agent, or the coating layer, suitably the water contact angle of the second coating layer comprising the superhydrophilic agent, may be ≤20 .

The superhydrophilic agent may comprise a (co)polymer or oligomer, such as a polymer electrolyte, or precursor thereof.

The superhydrophilic (co)polymer and/or hydrophilic (co)polymer may comprise a hydrogel, or be operable to form a hydrogel upon contact with water.

The superhydrophilic agent (co)polymer may be formed from monomers including a vinyl monomer, such as styrene sulfonate salt, vinyl ether (such as methyl vinyl ether), N-vinyl-2-pyrrolidone (NVP), vinyl acetate (VAc); a silane-based monomer and/or its derivatives; an acrylic monomer, such as a (hetero)aliphatic (alk)acrylate, acrylic acids and salts thereof, bisphenol acrylics, fluorinated acrylate, methacrylate, polyfunctional acrylate, hydroxyethoxyethyl methacrylate (HEEMA), hydroxydiethoxyethylmethacrylate (HDEEMA), methoxyethyl methacrylate (MEMA), methoxyethoxyethyl methacrylate (MEEMA), methoxydiethoxyethyl methacrylate (MDEEMA), ethylene glycol dimethacrylate (EGDMA), acrylic acid (AA), PEG acrylate (PEGA), PEG methacrylate (PEGMA), PEG diacrylate (PEGDA), PEG dimethacrylate (PEGDMA), bis(trimethylsilyloxy)methylsilylpropyl glycerol methacrylate (SiMA), methacryloyloxyethyl phosphorylcholine (MPC), 6-acetylthiohexyl methacrylate, acrylic anhydride, [2-(acryloyloxy)ethyl]trimethylammonium chloride, 2-(4-benzoyl-3-hydroxyphenoxy)ethyl acrylate, benzyl acrylate, or their trimethacrylate, dimethacrylate tri-block derivatives; thiol functionalised acrylate monomers, such as thiol functionalised (meth)acrylate; acryloyl chloride; acrylonitrile; maleimide; an acrylamide based monomer, such as acrylamide, methacrylamide; N,N-dimethylacrylamide (DMA), 2-acrylamido-2-methylpropane sulfonic acid, N-isopropyl AAm (NIPAAm), N-(2-hydroxypropyl)methacrylamide (HPMA), 4-acryloylmorpholine; carbohydrate monomer; a polyacid and/or polyol, such as maleic acid (such as maleic acid with a vinyl ether (e.g., Gantrez, partially neutralised with sodium)), ethylene glycol (EG); gelatin methacryloyl; and/or methacrylated hyaluronic acid, optionally with crosslinkers such as epichlorohydrin (ECH), N,N′-methylene-bis-acrylamide (BIS) and/or divinyl sulfone (DVS).

A superhydrophilic agent (co)polymer may have a molecular weight (Mw) of ≥2,000 g/mol, such as ≥4,000 g/mol, or ≥6,000 g/mol. For example, up to ≤30,000 g/mol, such as up to ≤20,000 g/mol, or up to ≤15,000 g/mol. For example, from 2,000 to 30,000 g/mol, such as from 4,000 to 20,000 g/mol, or from 6,000 to 15,000 g/mol.

The superhydrophilic agent (co)polymer may have a molecular weight (Mw) of ≥6,000 g/mol.

The superhydrophilic agent (co)polymer may have a molecular weight (Mw) of from 2,000 to 30,000 g/mol.

The coating or coating composition may comprise a film former, such as a linear and/or hydrophilic polymer (e.g. PVP etc). A film former may be selected from a polysaccharide or derivative thereof, such as cellulose or a derivative thereof, for example methylcellulose, hydroxyethyl cellulose, hydroxypropyl cellulose, hydroxypropyl methylcellulose, cellulose acetate phthalate, hydroxypropyl methylcellulose phthalate, carboxymethyl ethylcellulose, hydroxypropyl methylcellulose acetate succinate, ethylcellulose, sodium alginate; acrylic (co)polymers; vinyl (co)polymer, such as polyvinyl pyrrolidone; polyvinyl alcohol, polyvinyl acetate phthalate; polyethylene glycol, polyethyleneimine (PEI); and/or poly(ethylene)oxide. Preferably, the film former comprises a water-soluble film former, such as hydroxypropyl methylcellulose acetate succinate.

The amount of film former in the coating composition may be ≤10 wt % by dry weight of the coating composition, such as ≤5 wt %, such as ≤4 wt %, ≤3.5 wt %, ≤3 wt %, ≤2.5 wt %, preferably ≤2 wt %.

The hydrophilic agent, superhydrophilic agent, or precursors thereof, coating layer and/or film former, when present, may be at least partially crosslinked, or be operable to be at least partially crosslinked. The hydrophilic agent, superhydrophilic agent, or precursors thereof, film former and/or coating layer may be at least partially crosslinked by using an additive crosslinker. As such, the coating composition comprising the hydrophilic agent, superhydrophilic agent and/or film former may further comprise an additive crosslinker. The hydrophilic agent, superhydrophilic agent, or precursors thereof, coating layer and/or film former, may be at least partially self-crosslinked, or be operable to be self-crosslinked prior.

The hydrophilic, superhydrophilic (co)polymer, or precursors thereof, and/or film former (co)polymer, when present, may be formed from a crosslinker or residue thereof, suitably in an amount of >0.5% by weight of the total monomers of the (co)polymer, or ≥0.8 wt % or ≥1 wt %. For example, up to ≤15% by weight of the total monomers of the (co)polymer, up to ≤10 wt % or up to ≤5 wt %. For example, from 0.5 to 15% by weight of the total monomers of the (co)polymer, or from 0.8 to 10 wt % or from 1 to 5 wt %.

The coating composition may comprise a crosslinker in an amount of ≥0.5% by dry weight the composition, such as >0.8 wt % or ≥1 wt %. For example, up to ≤15% by dry weight the composition, such as up to ≤10 wt % or up to ≤5 wt %. For example, from 0.5 to 15% by by dry weight the composition, such as from 0.8 to 10 wt % or from 1 to 5 wt %.

The superhydrophilic (co)polymer may be formed from a crosslinker in an amount of ≥0.5% by weight of the total monomers of the (co)polymer.

The hydrophilic, superhydrophilic (co)polymer, or precursors thereof, and/or film former (co)polymer, when present, may be formed from a crosslinker or residue thereof, suitably in an amount of from 0.5 to 15% by weight of the total monomers of the (co)polymer.

The crosslinker may be a multi-functional acrylic or vinyl monomer, a divalent metal ion, multi-functional carbodiimide, multi-functional aziridine, silane; multi-functional epoxide and/or multi-functional isocyanate, or residue thereof.

The crosslinker may comprise tetramethylethylenediamine, methylene_bis-acrylamide, ethylene glycol_dimethacrylate, polyethylene glycol dimenthacrylate, triethylene glycol dimethacrylate N-isopropylacrylamide; N,N-diethylacylamide, epichlorohydrin (ECH), N,N′-methylene-bis-acrylamide (BIS), divinyl sulfone (DVS), citric acid, dicysteine peptides, dithiothreitol (DTT), glutaraldehyde; enzymatic crosslinking, such as transglutaminase, and a combination of horseradish peroxidase (HRP) and hydrogen peroxide, or a residue thereof.

The hydrophilic agent, superhydrophilic agent, or precursors thereof, and/or film former when present, may comprise a functional group that is operable to be crosslinked, or residue thereof. For example, the hydrophilic agent, superhydrophilic agent, or precursors thereof, and/or film former when present, may comprise acid functionality, such as carboxylic acid functionality, or residues thereof. In the coating layer, the crosslinking density may be at least 2 molar % of the crosslinkable functional groups, such as at least 5 molar % or at least 10 molar %.

The crosslinking density may be at least 2 molar % of the crosslinkable functional groups.

As used herein, the crosslinking density was measured by the following method. The polymer was swelled in a solvent until equilibrium. The swollen gel was then isolated and weighed. The weights of swelling solvent and polymer were determined after removing the solvent by vacuum-drying. The following equation was then applied:

Crosslink density, network chain per gram=[In(1−Vp)+(Vp)+X(Vp)^2]/{Dp(Vo)[(Vr)^(⅓)−(Vp)/2]}

where
Vp=Volume fraction of polymer in the swollen polymer
X=Huggins polymer-solvent interaction constant
Dp=Density of polymer (g/cm^3)
Vo=Molar volume of solvent (cm^3/mol)
Do=Density of solvent (g/cm^3)

### Here,

$$Vp = 1 / ( 1 + Q ) ,$$

Where Q is the ratio of the weight of solvent in swollen polymer (XDp) and the weight of polymer (XDo).

The superhydrophilic agent may be a polyelectrolyte (co)polymer selected from a (meth) acrylic acid (co)polymer; and/or a styrene sulfonate acid (co)polymer, wherein at least part of the acid is in the form of a suitable salt.

The superhydrophilic agent may be a polyelectrolyte copolymer selected from poly(styrene-alt-maleic acid) sodium, chitosan-g-poly(acrylic acid) copolymer sodium; 2-propenoic acid, 2-methyl, polymer with sodium; and/or 2-methyl-2 ((1-oxo-2-propen-1-yl) amino)-1-propanesulfonate.

The superhydrophilic agent may comprise a (co)polymer hydrogel selected from: carboxymethyl cellulose (CMC), and/or polyvinylpyrrolidone (PVP) hydrogel, crosslinked for example by tetra (ethylene glycol) dimethacrylate, such as via free radical polymerisation, suitably wherein at least part of the acid is in the form of a suitable salt, such as a carboxymethyl cellulose (CMC) sodium; N-isopropylacrylamide (NIPAAm) with poly(ethylene glycol)-co-poly(ϵ-caprolactone) (PEG-co-PCL), crosslinked for example by N,N′-methylene bisacrylamide and/or sodium alginate, for example by using template copolymerisation, or UV light or crosslinked by N,N,N′,N′-tetramethylethylenediamine (TEMED) and/or ammonium persulphate (APS) with UV light, such as alginate and alginate derivatives; 3-(methacryloyloxy)propyltris(trimethylsiloxy)silane, N,N-dimethylacrylamide, 3-(methacryloyloxy)propyltris(trimethylsiloxy)silane 1-vinyl-2-pyrrolidinone, and/or 2-hydroxyethylmethacrylate (TRIS-DMA-NVP-HEMA copolymer hydrogel).

Hydrogel when used herein in relation to the hydrophilic agent and the superhydrophilic agent may mean an insoluble polymeric network characterized by the presence of physical and/or chemical crosslinking among the polymer chains and the presence of water, suitably in a non-insignificant amount, such as in an amount of at least 10% of the total weight of the polymer composition. The hydrophilic agent and/or the superhydrophilic agent may be in the form of a dehydrated hydrogel that is operable to form a hydrated hydrogel upon contact with water.

The superhydrophilic agent may comprise a poly(styrene sulphonate salt) and/or a polyacrylic acid salt.

The “term” precursor when used herein in relation to the hydrophilic and superhydrophilic agents refers to a compound that is operable to form the hydrophilic or superhydrophilic agent using methods known to the skilled person. For example, the precursor may be an oligomer, or pre-crosslinked polymer which form the hydrophilic or superhydrophilic agent after chemical or physical crosslinking, such as with UV-light with photo-initialiser, heat treatment, etc. For example, a precursor may comprise a mixture of acrylamide and acrylic acid monomers with poly(allylamonium chloride), and with 2,2′-Azobis(2-methylpropionamidine) dihydrochloride (AIBA) as initiator, and N,N′-methylene bisacrylamide (MBAM) as crosslinker. This mixture may be considered to be a hydrophilic agent precursor as it is operable to form a hydrophilic agent in the coating layer via template polymerisation. Another example of a suitable precursor includes polyethylene glycol (PEG) mixed with triethylene glycol dimethacrylate (TEGDMA), which is operable to form the hydrophilic agent in the coating layer via UV light with a photo-initiator.

The coating composition may comprise a buffer agent, operable to maintain the composition at suitable pH range, such as tris(hydroxymethyl)aminomethane (Tris). The pH of the coating composition may be from 8 to 9, such as from 8 to 8.5.

The thickness of the coating, suitably of the first coating layer, may be from 1 nm to 2000 nm.

The thickness of the coating layer comprising the superhydrophilic agent may be up to 100 um.

The coating may comprise an intermediate layer between the baffle/membrane substrate and a first coating layer, and/or between a first coating layer and a second coating layer.

The intermediate layer may comprise an adhesion promoter selected from silane or a derivative thereof, tannic acid, dopamine or a derivative thereof, and/or dopamine peptide; amine; diamine; methacrylate; epoxy; methyl, isobutyl, phenyl, octyl, or vinyl, chloroalkyl; vinylbenzylamino based adhesion promoter; organometallic such as organotitanate, organozirconate, organoaluminate; chlorinated or chlorine-free polyolefin; polyol based adhesion promoter; and/or polyester based adhesion promoter.

The adhesion promoter may comprise a silane based adhesion promoter such as an acrylate and/or methacrylate functional silane, aldehyde functional silane, amino functional silane; such as amino alkoxysilane, anhydride functional silane, azide functional silane, carboxylate phosphonate and/or sulfonate functional silane, epoxy functional silane, ester functional silane, halogen functional silane, hydroxyl functional silane, isocyanate and/or masked isocyanate functional silane, phosphine and/or phosphate functional silane, sulfur functional silane, vinyl and/or olefin functional silane, multi-functional and/or polymeric silane, UV active and/or fluorescent silane, and/or chiral silane, trihydrosilane.

The adhesion promoter may comprise 3-aminopropyl trimethoxy silane The coated baffle/membrane may be formed by:
a. optionally, preparing a substrate by treating the substrate with physical rinsing, chemical treatment, radiation treatment, plasma treatment, and/or thermal treatment;
b. optionally, contacting the substrate with an intermediate layer coating composition to form an intermediate layer;
c. contacting thsubstrate with a coating composition comprising a hydrophilic agent or precursor thereof, and optionally further comprising a superhydrophilic agent or precursor thereof, to form a coating layer;
d. optionally, contacting the coating layer with an intermediate layer coating composition to form an intermediate layer;
e. if a superhydrophilic agent was not contacted with the substrate in step (c), contacting the coated substrate with a coating composition comprising a superhydrophilic agent or precursor thereof to form a further coating layer.

The coated baffle/membrane may be formed by:
a. optionally, preparing a substrate by treating the substrate with physical rinsing, chemical treatment, radiation treatment, plasma treatment, and/or thermal treatment;
b. optionally, contacting the substrate with an intermediate layer coating composition to form an intermediate layer;
c. optionally, contacting the substrate with a coating composition comprising a hydrophilic agent or precursor thereof to form a coating layer;
d. optionally, contacting the coating layer with an intermediate layer coating composition to form an intermediate layer;
e. contacting the optionally coated substrate with a coating composition comprising a superhydrophilic agent or precursor thereof to form the coating layer;
   wherein the coating layer comprising the superhydrophilic agent is at least partially crosslinked.

The coating may comprise a lamellar structure comprising at least two layers of two-dimensional material, and wherein the two-dimensional material comprises graphene or a derivative thereof. The coating may be formed from a coating composition comprising graphene or a derivative thereof.

The graphene or derivative thereof may be selected from one or more of graphene oxide, reduced graphene oxide, hydrated graphene and amino-based graphene, alkylamine functionalised graphene oxide, ammonia functionalised graphene oxide, amine functionalised reduced graphene oxide, octadecylamine functionalised reduced graphene oxide, and/or polymer graphene aerogel. Preferably, the graphene or derivative thereof is graphene oxide. Graphene and its derivatives may be obtained commercially from Sigma-Aldrich.

Suitably, the graphene or derivative thereof, preferably graphene oxide, comprises hydroxyl, carboxylic and/or epoxide groups. The oxygen content of the graphene or derivative thereof, preferably graphene oxide, may be 0% to 60% oxygen atomic percentage, such as 0% to 50% or 0% to 45% oxygen atomic percentage. Suitably, the oxygen content is from 20% to 25% or from 25% to 45%. Advantageously, when the water content is between 25% to 45% a surfactant may not be present in the composition. Preferably, the oxygen content is from 30% to 40% oxygen atomic percentage. Such a range can provide improved stability despite the absence of other stabilising components. Suitably, when the graphene or derivative is reduced graphene oxide, the oxygen content is from 5% to 20% oxygen atomic percentage. Oxygen content can be characterised by X-ray photoelectron spectroscopy (XPS).

The graphene or derivative thereof, suitably graphene oxide, may be optionally substituted with further functional groups. The optional functional groups may be grafted functional groups, and preferably grafted via reaction with the existing hydroxyl, carboxylic and epoxide groups of the graphene or derivative thereof. Functionalisation includes covalent modification and non-covalent modification. Covalent modification method can be subcategorised to nucleophilic substitution reaction, electrophilic substitution reaction, condensation reaction, and addition reaction. Examples of optional functional groups are amine groups; aliphatic amine groups, such as long-chain (e.g. C₁₈ to C₅₀) aliphatic amine groups; porphyrin-functionalised secondary amine groups, and/or 3-amino-propyltriethoxysilane groups. The graphene or derivative thereof may comprise amino groups, suitably grafted amino groups, and preferably to graphene oxide. Such functionalisation can provide for the improved selective sieving of ferric acid.

The graphene or derivative thereof according to any aspect of the present invention may be in the form of flakes having a size of from 1 nm to 5000 nm, such as between 50 nm to 750 nm, 100 nm to 500 nm, 100 nm to 400 nm. The graphene or derivative thereof according to any aspect of the present invention may be in the form of flakes having a size of from 100 nm to 3500 nm, such as from 200 nm to 3000 nm, 300 nm to 2500 nm or 400 nm to 2000 nm, preferably from 500 nm to 1500 nm. The graphene or derivative thereof according to any aspect of the present invention may be in the form of flakes having a size of from 500 nm to 4000 nm, 500 nm to 3500 nm, 500 nm to 3000 nm, 750 nm to 3000 nm, 1000 nm to 3000 nm, such as 1250 nm to 2750 nm or preferably 1500 nm to 2500 nm. Suitably, the size distribution of the graphene flakes or derivative thereof is such that at least 30wt % of the graphene flakes or derivative thereof have a diameter of between 1 nm to 5000 nm, such as between 1 nm to 750 nm, 100 nm to 500 nm, 100 nm to 400 nm; or between 100 nm to 3500 nm, such as from 200 nm to 3000 nm, 300 nm to 2500 nm or 400 nm to 2000 nm, preferably from 500 nm to 1500 nm; or between 500 nm to 4000 nm, 500 nm to 3500 nm, 500 nm to 3000 nm, 750 nm to 3000 nm, 1000 nm to 3000 nm, such as 1250 nm to 2750 nm or preferably 1500 nm to 2500 nm, more preferably at least 40wt %, 50wt %, 60wt %, 70wt % and most preferably at least 80wt % or at least 90wt % or 95wt % or 98wt % or 99wt %. The size of the graphene flakes or derivative thereof and size distribution may be measured using transmission electron microscopy (TEM, JEM-2100F, JEOL Ltd. Japan).

The graphene or derivative thereof may be in the form of a monolayer or multi-layered particle, preferably a monolayer. The graphene flakes or derivative thereof may be formed of single, two or few layers of graphene or derivative thereof, wherein few may be defined as between 3 and 20 layers. Suitably, the graphene flakes or derivative thereof comprise between 1 to 15 layers, such as between 2 to 10 layers or 5 to 15 layers. Suitably, at least 30wt % of the graphene flakes or derivative thereof comprise between 1 to 15 layers, such as between 1to 10 layers or 5 to 15 layers, more preferably at least 40wt %, 50wt %, 60wt %, 70wt % and most preferably at least 80wt % or at least 90wt % or 95wt % or 98wt % or 99wt %. The number of layers in the graphene flakes or derivative thereof may be measured using atomic force microscopy (AFM or transmission electron microscopy (TEM)) (TT-AFM, AFM workshop Co., CA, USA).

Suitably, the d-spacing between adjacent lattice planes in the graphene or derivative thereof is from 0.34 nm to 1000 nm, such as from 0.34 nm to 500 nm, or from 0.4 nm to 500 nm, or from 0.4 nm to 250 nm, such as from 0.4 nm to 200 nm, or from 0.4 nm to 150 nm, or from 0.4 nm to 100 nm, or from 0.4 nm to 50 nm, or from 0.4 nm to 25 nm, or from 0.4 nm to 10 nm, or from 0.4 nm to 5 nm, such as from 0.45 nm to 4 nm, from 0.5 nm to 3 nm, 0.55 nm to 2 nm, or 0.55 nm to 1.5 nm, or 0.6 nm to 1.2 nm, for example, 0.6 nm to 1.1 nm, 0.6 nm to 1 nm, 0.6 nm to 0.9 nm, or 0.6 nm to 0.8 nm.

The coating may comprise materials, suitably two-dimensional materials, other than graphene or derivatives thereof. For example, other materials of the coating may be selected from one or more of silicene, germanene, stanene, boron-nitride, suitably h-boron nitride, carbon nitride, metal-organic nanosheets, molybdenum disulfide, and tungsten disulfide, polymer/graphene aerogel.

The materials of the coating may be produced using any of the suitable methods known to the skilled person. Two-dimensional silicene, germanene and stanene may be produced by surface assisted epitaxial growth under ultrahigh vacuum. Hexagonal two-dimensional h-boron nitride may be produced by several methods, such as mechanical cleavage, unzipping of boron nitride nanotubes, chemical functionalisation and sonication, solid-state reaction and solvent exfoliation and sonication. Among these methods, chemical method has been found to provide the highest yield. For example, h-boron nitride may be synthesised on single-crystal transition metal substrates using borazine as boron and nitride sources. Two-dimensional carbon nitride can be prepared via direct microwave heating of melamine and carbon fibre. Metal-organic frameworks (MOFs) can be produced by in-situ solvothermal synthesis method by mixing ingredients at high temperatures such as 100-140° C., followed by filtration. Two-dimensional molybdenum disulfide can be obtained by a few methods, such as mechanical exfoliation, liquid exfoliation and chemical exfoliation. Among these methods, chemical exfoliation has been found to provide high yield. One example is chemical exfoliation using lithium to chemically exfoliate molybdenum disulfide using centrifuge and filtration. Two-dimensional tungsten disulfide can be prepared by a deposition-thermal annealing method: vacuum deposition of tungsten and followed by thermal annealing by addition of sulphur. Polymer/graphene aerogel can be produced via coupling and subsequent freeze-drying using polyethylene glycol grafted graphene oxide.

The method of applying the coating composition to the membrane may comprise applying a coating composition comprising the graphene or derivative thereof onto the substrate. The method may comprise contacting the coating composition onto the substrate using gravity deposition, vacuum deposition, pressure deposition; printing such as inkjet printing, aerosol printing, 3D printing, offset lithography printing, gravure printing, flexographic printing techniques, pad printing; curtain coating, dip coating, spin coating, and other printing or coating techniques known to those skilled in the art.

Further details of the application methods are disclosed in published PCT patent application WO2019106344, specifically, paragraphs [47] to [49] and [61] to [69] inclusive. The entire contents paragraphs [47] to [49] and [61] to [69] inclusive thereof are fully incorporated herein by reference.

The coating composition may be a liquid composition comprising a liquid medium and the graphene or derivative thereof. The coating compositions of the present invention may comprise solvent, non-solvent or solvent-less, and may be UV curable compositions, e-beam curable compositions etc. When formulated as a liquid composition for use in the present invention, e.g. as a solution, dispersion or suspension, a suitable carrier liquid or solvent may be aqueous or organic, and other components will be chosen accordingly. For example, the liquid carrier may comprise water or an organic solvent such as ethanol, terpineol, dimethylformamide N-Methyl-2-pyrrolidone, isopropyl alcohol, mineral oil, ethylene glycol, or their mixtures, optionally with other materials to enhance performance and/or rheology of the composition including any one or more of binders, drying additives, antioxidants, reducing agents, lubricating agents, plasticisers, waxes, chelating agents, surfactants, pigments, defoamers and sensitisers.

Further details of the coating composition are disclosed in published PCT patent application WO2019106344, specifically, paragraphs [51] to [60] inclusive. The entire contents paragraphs [51] to [60] inclusive thereof are fully incorporated herein by reference.

The coating may comprise a lamellar structure comprising at least two layers of two-dimensional material, and wherein the two-dimensional material comprises a transition metal dichalcogenide. The coating may be formed from a coating composition comprising a transition metal dichalcogenide.

The transition metal dichalcogenide may be according to formula (I)

MₐX_{b}, (I)

wherein with M is a transition metal atom, such as Mo, W, Nb and Ni;
X is a chalcogen atom, preferably S, Se, or Te;
wherein 0<a≤1 and 0<b≤2.

The transition metal dichalcogenide may be selected from one or more of MoS_{2,} MoSe₂, WS₂, WSe₂, MoₐW₁₋ₐS₂, MoₐW₁₋ₐSe₂, MoS_{b}Se_{2-b}, WS_{b}Se2-b, or MoₐW₁₋ₐS_{b}Se_{2-b}, where 0<a≤1 and 0<b≤2, or combination thereof. Preferably, the transition metal dichalcogenide is selected from MoS₂, WS₂, MoSe₂, WSe₂. Most preferably from MoS₂ and WS₂. Such transition metal dichalcogenide is available commercially from ACS Material.

The transition metal dichalcogenide may be in the form of flakes having an average size of from 1 nm to 5000 nm, such as between 50 to 750 nm, 75 nm to 500 nm, 100 nm to 400 nm, for example 130 nm to 300 nm, 150 nm to 290 nm, or 160 nm to 280 nm, suitably 170 nm to 270 nm, 180 nm to 260 nm or preferably 190 nm to 250 nm. Suitably, the size distribution of the transition metal dichalcogenide flakes is such that at least 30 wt % of the transition metal dichalcogenide flakes have a diameter of between 1 nm to 5000 nm, such as between 50 to 750 nm, 75 nm to 500 nm, 100 nm to 400 nm, for example 130 nm to 300 nm, 150 nm to 290 nm, or 160 nm to 280 nm, suitably 170 nm to 270 nm, 180 nm to 260 nm or preferably 190 nm to 250 nm more preferably at least 40 wt %, 50 wt %, 60 wt %, 70 wt % and most preferably at least 80 wt % or at least 90 wt % or 95 wt % or 98 wt % or 99 wt %. The size of the transition metal dichalcogenide thereof and size distribution may be measured using transmission electron microscopy (TEM, JEM-2100F, JEOL Ltd. Japan).

For example, lateral sizes of the two-dimensional layers across a sample may be measured using transmission electron microscopy (TEM, JEM-2100F, JEOL Ltd. Japan), and the number (Ni) of the same sized nanosheets (Mi) measured. The average size may then be calculated by Equation 1:

$$Average size = {\sum }_{i = 1}^{∞} {N}_{i} {M}_{i} / {\sum }_{i = 1}^{∞} {N}_{i}$$

where Mi is diameter of the nanosheets, and Ni is the number of the size with diameter Mi.

The transition metal dichalcogenide may be in the form of a monolayer or multi-layered particle or flake, preferably a monolayer. The transition metal dichalcogenide flakes may be formed of single, two or few layers of transition metal dichalcogenide, wherein few may be defined as between 3 and 100 layers. Suitably, the transition metal dichalcogenide flakes comprise between 1 to 100 layers, such as between 2 to 75 layers or 5 to 50 layers or 10 to 25 layers. Suitably, at least 30wt % of the transition metal dichalcogenide comprise between 1 to 30 layers, such as between 5 to 30 layers or 5 to 10 layers, more preferably at least 40 wt %, 50 wt %, 60 wt %, 70 wt % and most preferably at least 80 wt % or at least 90 wt % or 95 wt % or 98 wt % or 99 wt %. The number of layers in the transition metal dichalcogenide flakes thereof may be measured using atomic force microscopy (AFM or transmission electron microscopy (TEM)) (TT-AFM, AFM workshop Co., CA, USA).

Suitably, the d-spacing between adjacent lattice planes in the transition metal dichalcogenide or mixture thereof is from 0.34 nm to 5000 nm, such as from 0.34 nm to 1000 nm, or from 0.4 to 500 nm, or from 0.4 to 250 nm, such as from 0.4 to 200 nm, or from 0.4 to 150 nm, or from 0.4 to 100 nm, or from 0.4 to 50 nm, or from 0.4 to 25 nm, or from 0.4 to 10 nm, or from 0.4 to 8 nm, such as from 0.4 to 7 nm, from 0.45 to 6 nm, 0.50 to 5 nm, or 0.55 to 4 nm, or 0.6 to 3 nm, for example 0.6 to 2.5 nm, 0.6 to 1 nm, 0.6 to 2 nm, or 0.6 to 1.5 nm.

The coating may comprise materials, suitably two-dimensional materials, other than the transition metal dichalcogenide thereof. For example, other materials of the coating may be selected from one or more of silicene, germanene, stanene, boron-nitride, suitably h-boron nitride, carbon nitride, metal-organic nanosheets, graphene, graphene oxide, reduced graphene oxide functionalised graphene oxide and polymer/graphene aerogel.

Further details of the application methods are disclosed in published PCT patent application WO2019/122828, specifically, paragraphs [73] to [77] inclusive. The entire contents paragraphs [73] to [77] inclusive thereof are fully incorporated herein by reference.

Further details of the coating composition are disclosed in published PCT patent application WO2019/122828, specifically, paragraphs [46] to [61] inclusive. The entire contents paragraphs [46] to [61] inclusive thereof are fully incorporated herein by reference.

The coating may comprise a metal-organic framework (MOF). The coating may be formed from a coating composition comprising a MOF.

The metal-organic framework materials of any aspect of the present invention may be one-dimensional, two-dimensional or three-dimensional. Preferably, the MOF is porous. The MOF may comprise a network of secondary building units (SBUs), or metal ion core/metal subunit cluster core nodes, and organic linkers (or ligands) connecting the SBUS or nodes.

The MOF may be in continuous phase in the coating or may be in the form of flakes and/or particles. A MOF synthesised in the presence of first support portion may be in the form of continuous phase. A MOF formed prior to contact with the first support portion may be in the form of flakes and/or particles.

The SBUs or nodes, being sub units of the MOF, may comprise metal selected from one or more transition metal cations, such as one or more of Cr(III), Fe(II), Fe(III), Al(III), Co(II), Ru(III), Os(III), Hf(IV), Ni, Mn, V, Sc, Y(III), Cu(II), Cu(I), Zn(II), Zr(IV), Cd, Pb, Ba, Ag(I), Au, AuPd, Ni/Co, lanthanides, actinides, such as Lu, Tb(III), Dy(III), Ho(III), Er(III), Yb(III). Preferably Cr(III), Fe(II), Fe(III), Al(III), Co(II), Ru(III), Os(III), Hf(IV), Ni, Mn, V, Sc, Y(III), Cu(II), Cu(I), Zn(II), Zr(IV), Cd, Pb, Ba, Ag(I), Ni/Co, lanthanides, actinides, such as Lu, Tb(III), Dy(III), Ho(III), Er(III), Yb(III). More preferably Cr(III), Fe(II), Fe(III), Al(III), Co(II), Hf(IV), Ni, Mn, V, Sc, Y(III), Cu(II), Cu(I), Zn(II), Zr(IV), Cd, Pb, Ag(I), Ni/Co, lanthanides, actinides, such as Lu, Tb(III), Dy(III), Ho(III), Er(III), Yb(III), more preferably Cr(III), Fe(II), Fe(III), Al(III), Co(II), Hf(IV), Ni, Mn, V, Y(III), Cu(II), Cu(I), Zn(II), Zr(IV), Cd, Ag(I), Ni/Co, lanthanides, actinides, such as Lu, Tb(III), Dy(III), Ho(III), Er(III), Yb(III). The secondary building unit (SBU) may comprise: three, four, five, six, eight, nine, ten, eleven, twelve, fifteen or sixteen points of extension.

The SBU or node may be a transition-metal carboxylate cluster. The SBUs or nodes may be one or more selected from the group consisting of Zn4O(COO6, Cu2(COO)4, Cr3O(H2O)3(COO)6, and Zr6O4(OH)10(H2O)6(COO)6), Mg2(OH2)2(COO), RE4(μ3-O)2(COO)8, RE4(μ3-O)2, wherein RE is Y(III), Tb(III), Dy(III), Ho(III), Er(III), and/or Yb(III)). The structures of SBUs can be identified by X-Ray diffraction using methods well known to the skilled person.

Organic linkers suitable for use in the present invention include those operable to be used to form MOFs for water treatment, molecule separation, and biofiltration related applications. Such linkers may form strong bonds to metal cores, provide large pore sizes, provide high porosity, provide selective absorption and/or capacity.

The organic linkers of the MOF may be formed from a wide range of organic molecules, such as one or more carboxylate linkers; N-heterocyclic linkers; phosphonate linkers; sulphonate linkers, metallo linkers, such a carboxylate-metallo linkers; and mixtures and derivatives thereof.

The organic linkers may comprise one or more of ditopic, tritopic, tetratopic, hexatopic, octatopic linkers. The organic linkers may comprise desymmetrised linkers.

MOFs suitable for use in the present invention include those operable to be used water treatment, molecule separation, biofiltration and related applications. Suitable MOFs preferably have water and chemical stability. The MOFs may have water insoluble linkers, and/or solvent-stable linkers, and/or strong covalent bonds between SBU and linkers, and/or multi-covalent bonds between SBU and linkers. Water and chemical stability may mean that the MOFs do not fully disassemble to linkers and SBUs in the presence of water and/or chemicals. Suitable MOFs may have covalent bond links between the linkers and the SBUs or nodes, and/or coordinate bonding between the linkers and the SBUs or nodes.

Suitable MOFs may have a high surface area and/or large pore sizes. The MOF may have a surface area of at least 10 m²/g, such as 100 to 9,000 m²/g, preferably 100 to 8,000 m²/g or 500 to 8,000 m²/g. The surface area can be measured using the known Brunauer, Emmett and Teller (BET) technique. The MOFs according to any aspect of the present invention, suitably in the form of porous flakes or particles, may have an average pore size of from 0.1 nm to 1000 nm, 0.1 to 950 nm, 0.2 to 900 nm, 0.2 to 850 nm, preferably 0.2 to 800 nm, 0.3 to 700 nm, preferably 0.4 to 650, 0.4 to 550 nm, 0.5 to 500 nm, 0.5 to 450 nm, 0.2 nm to 100 nm, such as between 0.2 nm to 90 nm, 0.3 nm to 75 nm, 0.4 nm to 50 nm, for example, 0.4 nm to 40 nm, 0.4 nm to 30 nm, or 0.4 nm to 20 nm, suitably 0.4 nm to 15 nm, 0.4 nm to 10 nm.

The MOF may comprise a pillared-layer MOF. Suitably, in a pillared-layer MOF 2D sheets function as scaffolds for organic linkers, such as dipyridyl linkers. Advantageously, this can allow for diverse functionalities to be incorporated into the MOF, such as —SO₃²⁻_groups. The use of —SO₃²⁻_groups can induce a polarized environment and strong acid-base interaction with acidic guests like CO2. Furthermore, different pillar linker groups, such as —N═N— compared to —CH═CH—, provide different selectivity to H₂O and methanol.

The MOF may comprise a functional group. The MOF may in particular be adapted for water treatment, molecule separation, and biofiltration related applications by the MOF comprising a functional group, suitably on one or more of the organic linkers. Said functional groups may provide selectivity and/or increase pore sizes for high adsorption capacity or high flux rate. The functional group may be selected from one or more of the group consisting of —NH₂, —Br, —Cl, —I, —(CH₂)ₙ—CH₃ wherein n is 1 to 10, such as CH₃CH₂CH₂O—, CH₃CH₂CH₂CH₂O—, ben-C₄H₄, methyl, —COOH, —OH. For example, the MOF may be an IRMOF, such as IRMOF-1, IRMOF-2, IRMOF-3, IRMOF-4, IRMOF-5, IRMOF-6, IRMOF-7, IRMOF-8, IRMOF-9, IRMOF-10, IRMOF-16, IRMOF-11, IRMOF-12, IRMOF-13, IRMOF-14, IRMOF-15; and/or a CAU, such as CAU-10-OH, CAU-10-NH₂, CAU-10-H, CAU-10-CH₃; and/or MIL-125-NH2; and/or UiO-66 (Zr)-(CH3)2.

The coating may be operable to provide size exclusion filtration, fouling resistance, and/or adsorption, such as size exclusion and fouling resistance.

The pore size of the MOF may be tailored by using different species of MOFs or different organic linkers with different lengths. For example, the pore size of the MOF may be at least 0.6 nm (e.g. ZIF-78), such as at least 0.8 nm (e.g. ZIF-81), or at least 0.9 nm (e.g. ZIF-79) or at least 1.2 nm (e.g. ZIF-69), or at least 1.3 nm (e.g. ZIF-68) or at least 1.6 nm (e.g. ZIF-82), such as at least 1.8 nm (e.g. ZIF-70), or at least 1.8 nm (e.g. IRMOF-10), or at least 2.8 nm (e.g. MOF-177).

The MOF may comprise MOF-74 adapted by replacing one or more of the original linkers containing one phenyl ring with a linker containing two, three, four, five, six, seven, nine, ten or eleven phenyl rings. Such an adaption can alter the pore size from ˜1.4 nm to ˜2.0 nm, to ˜2.6 nm, to ˜3.3 nm, to ˜4.2 nm, to ˜4.8 nm, to ˜5.7 nm, to ˜7.2 nm, to ˜9.5 nm, respectively.

The MOF may be hydrophobic. The hydrophobic MOF may be selected from one or more of MIL-101(Cr), NiDOBDC, HKUST-1, AI(OH)(2,6-ndc) (ndc is naphthalendicarboxylate), MIL-100-Fe, UiO-66, ZIF family, such as ZIF 71, ZIF 74, ZIF-1, ZIF-4, ZIF-6, ZIF-11, ZIF-9, and ZIF 8. Advantageously, the use of such MOFs can improve the fouling resistance of the membrane.

The MOF may comprise an adsorption promoting MOF, for example, UiO-66 or UiO-66-NH2, preferably UiO-66-NH2, which has been found to adsorb cationic dyes from aqueous solution more effectively than anionic dyes due to favourable electrostatic interactions between the adsorbents and cationic dyes. In particular, UiO-66-NH2 has been found to provide much higher adsorption capacity for cationic dyes and lower adsorption capacity for anionic dyes than UiO-66.

The MOFs may comprise nanochannels, suitably the MOFs are in the form of flakes or particles comprising nanochannels. The average nanochannel diameter may be from 0.2 nm to 100 nm, such as between 0.2 to 90 nm, 0.3 nm to 75 nm, 0.4 nm to 50 nm, for example 0.5 nm to 40 nm, 0.5 nm to 30 nm, or 0.5 nm to 20 nm, suitably 0.5 nm to 15 nm, 0.5 nm to 10 nm or preferably 0.5 nm to 8 nm.

The MOF may comprise functional groups selected from one or more of amine, aldehyde, alkynes, and/or azide. MOFs pores may be modified for selective sieving and to provide higher efficiency by modification methods, suitably post-synthetic, on the linkers and/or the secondary building units/nodes, such as covalent post-synthetic modification method of amine, or aldehyde, or alkynes, or azides functional groups. Specific functional groups may be induced to MOF(s) for specific application. For example, adding-NH2 to UiO-66 to make UiO-66-NH2 has been found to improve ferric acid adsorption, and adding sulfone bearing groups to iso IRMOF-16 by, for example, oxidation using dimethyldioxirane, in order to create compatible interaction between the coating and first support portion.

The MOFs of the present invention may be synthesised according to the required property or purchased from commercial supplier. Suitable commercially available metal-organic framework materials can be purchased from BASF, Sigma-Aldrich, or Strem Chemicals.

The methods used to synthesise MOFs for the present invention are those conventional in the art and may be solvothermal synthesis, microwave-assisted synthesis, electrochemical synthesis etc.

A modulator may be used during synthesis of the MOF to control the MOF particle size, the modulator may be benzoic acid.

The MOF may be in the form of a crystallised continuous phase or particles or flakes compacted and interacting or fused to each other forming the coating. Preferably the MOF is in the form of particles or flakes.

The size distribution of the MOF flakes or particles may be such that at least 30wt % of the MOF flakes or particles have a size of between 1 nm to 10000 nm, such as between 2 to 7500 nm, 5 nm to 5000 nm, 10 nm to 4000 nm, for example 15 nm to 3500 nm, 20 nm to 3000 nm, or 25 nm to 3000 nm, suitably 30 nm to 2500 nm, 40 nm to 2500 nm or preferably 50 nm to 2500 nm more preferably at least 40wt %, 50wt %, 60wt %, 70wt % and most preferably at least 80wt % or at least 90wt % or 95wt % or 98wt % or 99wt %. The size of the MOF and size distribution may be measured using transmission electron microscopy (TEM, JEM-2100F, JEOL Ltd. Japan).

For example, lateral sizes of two-dimensional layers across a sample of a MOF may be measured using transmission electron microscopy (TEM, JEM-2100F, JEOL Ltd. Japan), and the number (Ni) of the same sized nanosheets (Mi) measured. The average size may then be calculated by Equation 1:

$$Average size = {\sum }_{i = 1}^{∞} {N}_{i} {M}_{i} / {\sum }_{i = 1}^{∞} {N}_{i}$$

where Mᵢ is diameter of the nanosheets, and Nᵢ is the number of the size with diameter Mᵢ.

The coating may comprise additives to tailor the properties of the coating, such as other metals; and/or fibres, such as metal oxide nanostrands; and/or dopants such as Au, Fe, Cu, Cu(OH)₂, Cd(OH)₂ and/or Zr(OH)₂. Such additives may be added to the membrane to control the pore sizes and channel architecture of MOF and/or create nanochannels for high water flux rate. Any type of suitable fibres, such as continuous or stapled fibres, having diameter of 0.1-1000 nm may be incorporated within the membrane. Such as 0.1 to 850 nm, 0.5 to 500 nm, or 0.5 to 100 nm, 0.75 to 75 nm, preferably, 0.75 to 50 nm. Suitably, the fibres are removed before use, such as by mechanical removal or by dissolution, etc.

Further details of the application methods are disclosed in published PCT patent application WO2019/186134, specifically, paragraphs [117], [118] and [126] to [130] inclusive.

The entire contents paragraphs [117], [118] and [126] to [130] inclusive thereof are fully incorporated herein by reference.

Further details of the coating composition are disclosed in published PCT patent application WO2019/186134, specifically, paragraphs [97] to [116] inclusive. The entire contents paragraphs [97] to [116] inclusive thereof are fully incorporated herein by reference.

The coating may further comprise nanochannels formed by the use of fibres in the production of the coating. Advantageously the presence of nanochannels within the coating have been found to significantly increase the water flux by incorporating continuous or chopped fibres having diameter of 0.5-1000 nm during the manufacture process followed by removal of the fibres.

The nanochannels in the coating may have a diameter of 1 to 750 nm, such as 1 to 500 nm, or 1 to 250 nm, for example, 1 to 150 nm or 1 to 100 nm, for example 1 to 50 nm or 1 to 25 nm, such as 1 to 10 nm or preferably 1 to 5 nm.

The two-dimensional material of the coating may be treated two-dimensional material. The two-dimensional material may be treated after formation of the coating. The treatment may cause a change to the functional groups of the two-dimensional material, such as by application of high energy radiation such as laser radiation, chemicals, heat, thermal heat and/or pressure to the two-dimensional material.

The two-dimensional material may be treated, suitably reduced, by exposing the two-dimensional material to radiation, such as laser radiation, microwave radiation, UV radiation, E-beam radiation, plasma treatment, electron radiation, soft X-ray radiation, gamma radiation, alpha radiation; chemical treatment, pressure treatment and/or thermal treatment, preferably, laser radiation and/or plasma treatment.

The coating may comprise multiple coating layers, wherein at least one of the layers was treated before deposition of a subsequent layer. Preferably, each layer was treated before deposition of the subsequent layer. The layers of coating layer comprising multiple coating layers may have been subjected to different treatments, in terms of the type of treatment and/or the extent of the treatment. As such, at least one of the layers may comprise two-dimensional material having different functionality to another layer. For example, the layers may comprise a gradient of decreasing reduction level in the two-dimensional material from the top of the coating layer towards the bottom of the coating layer adjacent to the substrate. The gradient may be created in the reverse direction.

The presence of the gradient may increase the adhesion between the coating and substrate, and may also increase the fouling resistance of the overall membrane.

Treatment of the two-dimensional material on the substrate may cause a change in the functional groups of the two-dimensional material, for example, a change to the number, species and/or distribution of the functional groups. For example, treatment may reduce the two-dimensional material and/or may functionalise the two-dimensional material by adding functionality to the two-dimensional material.

Treatment of the two-dimensional material thereof to functionalise the two-dimensional material may add or change the functional groups of the two-dimensional material, for example by reaction with existing hydroxyl, carboxylic and/or epoxide groups of the two-dimensional material. Functionalisation includes covalent modification and non-covalent modification. Covalent modification method can be subcategorised to nucleophilic substitution reaction, electrophilic substitution reaction, condensation reaction, and addition reaction.

The two-dimensional material may be treated, suitably reduced, by exposing the two-dimensional material to radiation, such as laser radiation, microwave radiation, UV radiation, E-beam radiation, plasma treatment, electron radiation, soft X-ray radiation, gamma radiation, alpha radiation; chemical treatment and/or thermal treatment. Preferably, laser radiation and plasma treatment.

Chemical, thermal or radiation treatment of the two-dimensional material on the substrate can be used to form chemically reduced GO (CRGO), thermally reduced graphene oxide (TRGO) or radiation reduced graphene oxide (RRGO).

The hydrophilicity of treated membrane may be controlled by the functional groups or polar atom percentage, such as oxygen or nitrogen left at the surface after treatment.

The membrane may comprise a porous ceramic member, wherein the porous ceramic member comprises a first support portion operable to support a coating and further comprises a second support portion, wherein the second support portion has a higher D₇₅ average pore size than the D₇₅ average pore size of the first support portion, wherein the second support portion comprises a lattice structure that has a porosity percentage of ≥10%, and wherein the porous ceramic member has a tensile strength operable to withstand feed application pressure of ≥100kPa (1 bar). The membrane comprising a porous ceramic member may further comprise a coating supported on the porous ceramic member, specifically, wherein the coating extends across at least a portion of the first support portion. For example, the lattice structure of the second support portion may have a porosity percentage of ≥15%, such as ≥25% or ≥40%.

Advantageously, a membrane comprising the porous ceramic member may have thinner walls due to an additively manufactured porous ceramic lattice structure which allows increased packing density of membrane structures, creating more active surface area within the membrane. Thinner membrane walls also lead to less dead-end pores and a less tortuous pathway, increasing flux across the membrane.

The first support portion may have an average thickness of ≥10 μm, such as ≥20 μm, ≥30 μm, ≥40 μm, such as ≥50 μm. The first support portion may have an average thickness of ≤1000 μm, such as ≤800 μm, ≤600 μm, ≤400 μm, such as ≤200 μm. The first support portion may have an average thickness of from between 10 μm to 1000 μm, such as from 20 to 800 μm or from 30 to 600 μm, such as 40 to 400 μm or 50 to 200 μm, such as 50 to 150 μm or 50 to 100 μm. The first support portion as referred to herein, may refer to a ceramic surface between the feed inlet side and the permeate outlet side.

The second support portion may be operable to produce substantially laminar flow towards a permeate collection point.

The second support portion may comprise turbulent flow paths. Advantageously, this allows better homogenisation of fluid content.

The membrane device of the present invention may comprise a feed flow channel, suitably a plurality of feed flow channels, such as a plurality of substantially linear, and optionally substantially parallel feed flow channels. The feed flow channel may be substantially cylindrical.

The average width/diameter of the feed flow channel may be ≥0.1 mm, such as ≥0.3 mm or ≥0.5 mm. The “width” in the present context is intended to mean the largest lateral dimension of the channel. The average width/diameter of the feed flow channel may be ≤10 mm, such as ≤7 mm or ≤5 mm. The average width/diameter of the feed flow channel may be from 0.1 to 10 mm, such as from 0.3 to 7 mm or from 0.5 to 5 mm.

The membrane may comprise at least two feed flow channels that are spaced along at least a portion of their lengths by the first and second support portions, for example spaced by two first support portions with a second support portion arranged between the two first support portions.

The membrane may comprise a channel pitch, such an average pitch, of ≤14 mm, such as ≤10 mm or ≤7 mm. The membrane may comprise a channel pitch, such an average pitch, of ≥0.13 mm, such as ≥0.36 mm or ≥0.59 mm. The membrane may comprise a channel pitch, such an average pitch, of from 0.13 mm to 14 mm, such as from 0.36 mm to 10 mm or from 0.59 to 7 mm. As used herein, “channel pitch” refers to the distance between two adjacent feed channels as measured from the centre points of the feed channels.

The membrane may have a membrane packing density, such as a coating packing density, of ≥200 m²/m³, such as ≥350 m²/m³, such as ≥500 m²/m³.

Packing density may be calculated by any suitable method known to the skilled person. In general terms:

$$Packing density = \frac{membrane surface area}{Filter volume}$$

For example, when the membrane comprises cylindrical feed flow channels that packing density may be calculated as follows;

Dimensional measurements are made of:
r_{c}=Single channel radius
L=Channel length
r_{f}=Ceramic filter radius
L_{f}=Ceramic filter length
C=2 X x X Tc
V=Lfxx X rf2
C=Channel Circumference
L_{c}=Channel length
N=number of channels
V=ceramic filter volume

$$Packing density = \frac{N \times C \times {L}_{c}}{V}$$

The feed flow channel may extend into the porous ceramic member, suitably extend through the porous ceramic member, such as from one side of the porous ceramic member/membrane to a substantially opposed side of the member/device. The channel may be a cylindrical channel.

The flow channel may be integrally formed with the first and second support portions. The flow channel may comprise a channel wall formed at least partially of the first support portion, which may optionally comprise a coating arranged at least partially thereon the internal surface of the channel. The feed flow channel wall may be substantially formed by the first support member, optionally with a coating arranged at least partially thereover. Feed flowing through the channel may be operable to pass through the optional coating and the first support portion to thereby be filtered and form permeate flow through the second support portion and then flow out of the porous ceramic member to a permeate collection point. The second support portion may be shelled to provide a secondary permeate flow path through the porous ceramic member to the permeate collection point.

A “lattice structure” as referred to herein, means a three-dimensional structure composing one or more repeating unit cells, wherein the cells are interconnected such as to allow for fluid flow to adjacent cells. Triply period surfaces are included as part of the term “lattice”.

The lattice structure may comprise a unit cell that has a unit cell size of ≥0.01 mm, such as ≥0.1 mm, or ≥0.25 mm. The lattice structure may comprise a unit cell that has a unit cell size of ≤10 mm, such as ≤7 mm, or ≤5 mm.

The lattice structure may comprise a unit cell having a diamond structure, a cubic structure, a fluorite structure, an octet structure, a Kelvin cell structure, an iso-truss structure, a hex prism diamond structure, a truncated tube structure, a truncated octahedron structure, a Weaire-Phelan structure, a body centred cubic structure, and/or a face centred cubic structure. Optionally, the lattice structure may comprise a unit cell having a TPMS structure selected from a gyroid structure, a schwarz P structure, a schwarz D structure, a schwarz CLP structure, a schwarz H structure, a splitP structure, a neovius structure, or a double gyroid structure.

The second support portion may comprise a non-uniform lattice structure. Non-uniform lattice refers to a lattice structure where one or more type of unit cell is different from another type of unit cell in the overall lattice structure. Lattice non-uniformity may arise due to one or more different structural features. For example, a difference in the thickness of the lattice struts; a difference in the void space of the lattice unit cells; and/or a difference in the shape of the lattice unit cells.

The non-uniform lattice may comprise a gyroid structure with a gradient, suitably a linear gradient, changing bias length; a gyroid structure with (linear) gradient changing wall thickness; and/or a diamond lattice structure with (linear) gradient changing strut thickness.

The porous ceramic member may have a tensile strength operable to withstand feed application pressure of ≥0.5 MPa, such as ≥1 MPa or ≥2 MPa, optionally, in the range of 2 MPa to 200 GPa. As used herein, “operable to withstand feed application pressure” means that the porous ceramic member is operable to substantially function as required in the membrane at the given pressure substantially without damage to the structure of the porous ceramic member. As used herein, tensile strength was measured using a 3-point bend test.

A non-uniform lattice may comprise different lattice cell shapes.

When the second support portion comprises a non-uniform lattice structure, the average thickness of the second support portion may be from between 10 to 2000 μm.

Advantageously, a non-uniform lattice can be thicker in only the areas which require strength, thus reducing the amount of material used. The thickness also has a direct impact on the porosity, with thicker areas having a lower porosity and thinner areas having a higher porosity. A higher porosity means more area for liquid to move through, increasing the flux, so having only thickening areas where required, means higher porosity in the overall porous ceramic member.

The lattice unit cell may be shelled to form an internal hollow structure. At least a portion of the internal structure may form a series of interconnected voids with other shelled unit cells. This internal series of interconnected voids may be operable to provide a further conduit for the permeate to pass through. Advantageously, the interconnecting voids increase the overall porosity of the support portion while maintaining the required strength. The interconnecting voids may increase the porosity of the second support portion by about 5 to 15%, such as an increase in porosity of 10%. Suitably, the second support portion may have a porosity percentage of ≥45%, such as ≥50%, or >55%. The internal interconnected voids further add to the reduction of material used in the manufacturing of the membrane, reducing the weight and cost.

The porous ceramic member, the first support portion and/or the second support portion may be formed from a composition comprising a ceramic material that may comprise alumina, titania, zirconia, silicon carbide, hydroxyapatite, silicates, zeolite, metal oxides, or combinations thereof. The ceramic material may comprise alumina, titania, zirconia, silicon carbide, hydroxyapatite, silicates, zeolite, metal oxides, or combinations thereof. The first and second support portions comprise the same or different ceramic material.

The composition may comprise further additives. For example, the composition may comprise a pore forming agent (PFA), such as wheat particles, starch, PMMA, poppy seed and saw dust, a functionalising agent, a nano-material, a metal-organic framework and/or a two dimensional material such as a transition metal dichalcogenide and/or graphene oxide.

The second support portion may have any suitable D₇₅ average pore size. Preferably, the second support portion may be macroporous. The D₇₅ average pore size of the second support portion may be ≥0.1 mm, such as ≥0.2 mm, such as ≥0.3 mm, such as ≥0.4 mm. The D₇₅ average pore size of the second support portion may be ≤5 mm, such as ≤4 mm, such as ≤3 mm, such as ≤2 mm, such as ≤1 mm. The D₇₅ average pore size of the second support portion may be from about 0.1 to 5 mm, such as from about 0.2 to 4 mm, such as about 0.3 to 3 mm, such as about 0.4 to 1 mm.

The first support portion may have any suitable D₇₅ average pore size. The D₇₅ average pore size of the first support portion may be dictated by the components of the ceramic composition used, and the process of sintering the ceramic composition. The D₇₅ average pore size of the first support portion may be from 0.05 to 20 μm depending on the application. For example, the first support portion D₇₅ average pore size may change depending on whether the application relates to particle-filtration, micro-filtration, nano-filtration, and reverse osmosis-filtration. The first support portion may typically be microporous. Typically, the D75 average pore size of the first support portion may be ≥1 μm, such as ≥2 μm, such as ≥3 μm, such as ≥5 μm. The D₇₅ average pore size of the first support portion may be ≤20 μm, such as ≤15 μm, such as ≤10 μm. The D₇₅ average pore size of the first support portion may be from about 1 to 20 μm, such as about 2 to 15 μm, or about 3 to 10 μm.

The D₇₅ average pore size may be measured according to methods well known to the skilled person, such as by mercury intrusion porosimetry.

The first support portion may have a porosity percentage of ≥5%, such as ≥10%, such as ≥15% porosity. The first support portion may have a porosity percentage of ≤50%, such as ≤40%, typically, ≤35% porosity. The first support portion may have a porosity percentage of between about 5 to 50%, such as 10 to 40%, such as 15 to 35% porosity.

The second support portion may have a porosity percentage of ≥45%, such as ≥50%, such as ≥55%, such as ≥60%. The second support portion may have a porosity percentage of ≤80%, such as ≤75%, such as ≤70%. The second support portion may have a porosity percentage of between about 40 to 80%, preferably, about 60 to 80%, such as 70% porosity

The porosity is a measurement of the void space of a structure wherein the solid volume of the structure is divided by the total volume occupied dimensionally by the structure, expressed as a percentage.

$$n = ( 1 - \frac{{V}_{S}}{{V}_{T}} ) \times 100$$

where Vₛ is the solid and V_{T} is the total volume.

The first and second support portions may be integrally formed so as to form a continuous structure. Suitably, the first and second support portions are integrally formed by additive manufacturing.

The membrane may be produced by:
a. additively manufacturing the porous ceramic member to produce the lattice structure of the second support portion and to form the first support portion;
b. optionally, removing binder from the first support portion to form pores in the first support portion;
c. optionally, applying a coating to at least a portion of the first support portion, suitably by coating a coating composition onto the first support portion.

In step (a) the macrostructure of the first support portion may be formed but the pore structure of the first support portion may be formed in step (b). In such a process, step (a) may be considered to be the formation of the green part. Step (b) may be considered to be a de-binding and/or sintering step.

Advantageously, the first and/or second support portion may be produced, suitably printed, using an additive manufacturing process, preferably, the first and second support portions are additively manufactured so as to form an integral support structure. The additive manufacturing technique may be any suitable ceramic 3D printing technology. For example, the first and/or second support portion may be printed using binder jet printing, stereolithography, digital light processing, two-photon polymerisation, inkjet printing, direct ink writing, three-dimensional printing, selective laser sintering, selective laser melting, laminated object manufacturing, or fused deposition modelling.

The additive manufacture of the porous ceramic member provides a membrane with the mechanical strength required to support a coating during manufacture and filtration, whilst also balancing the high porosity and increased packing density to provide improved fluid flow during the final filter application.

In the membrane of the present invention, pressure may be used to push the water through the coating where contaminates are separated out and left in the water feed and uncontaminated water passes through onto the permeate side, where it is pushed through the porous ceramic member towards an exit of the membrane.

The term “shelled” referred to herein, means hollowed solid parts of a structure with

a given wall thickness.

The term “lamellar structure” herein means a structure having at least two overlapping layers. The term “membrane” herein means a porous barrier operable to assist with the separation of desired dissolved materials (solutes), colloids or particulates from the feed solutions. It may represent an interface between the feed flow and the permeate flow. The term “two-dimensional material” herein means a material with at least one dimension of less than 100 nm.

Turbulence is measured by the Reynolds number (Re):

$$Re = \frac{ρ uL}{μ}$$

Wherein ρ is the density of the fluid, u is the flow speed, L is the characteristic linear dimension, and μ is the dynamic viscosity of the fluid.

The baffle may be operable to be inserted into a membrane, such as a tubular membrane. The membrane, such as a tubular membrane, may be operable to be inserted into the baffle.

The baffle may be operable to extend along only a part of the membrane. The enhancement in cross flow velocities generated by the baffle of the present invention may last for a distance past the end point of the baffle due to the momentum of the flow. The pressure drop in the region past the baffle may be relatively smaller compared to the regions where the baffle is present as there is less obstruction. Thus the benefits of high shear at the membranes may be realised with reduced pressure drop.

The baffle may be operable to extend along at least 40% of the membrane, such as at least 50%, such as at least 60%.

The baffle may be operable to extend along up to 90% of the membrane, such as up to 80%, such as up to 70%.

The baffle may be operable to extend along 40 to 90% of the membrane, such as 50 to 80%, such as 60 to 70%.

The baffle may be operable to extend along substantially the full length of the membrane.

The baffle may be operable to provide a substantially consistent feed flow flux along the longitudinal length of the baffle.

The baffle may be operable to provide a higher velocity of feed flow toward the distal end of the baffle than the proximal end of the baffle. The baffle may be operable to provide higher pressure at the proximal end of the baffle than the distal end of the baffle.

The baffle for a membrane device may be operatable to provide reduction in specific energy consumption of at least 5%, such as 10%, such as at least 15% compared to a baffle having the aspect ratio of the first or second geometry portion as a constant aspect ratio through the longitudinal length of the membrane.

The feed flow may comprise suspended solid particulates, such as algae. Any feed that comprises suspended solid particulates may benefit from reduced SEC and less fouling. The feed flow may comprise juices, such as high solids content juices, for example a fruit juice; milk; sugar-containing feed; produced/waste water; critical metal-containing feed; and/or enzymes. The feed flow may be a high solids feed flow. The solid contents of the feed flow may be up to 40% by total weight of the feed flow.

The baffle according to the present invention may be operable for use in a tubular membrane in applications where suspended solid particulates are effectively required to be removed from the feed solution in an energy efficient method. Accordingly, the baffle may be operable for use in, but is not limited to, applications such as concentrating algae, concentrating and clarifying high solid contents juices, separating proteins from milk, clarifying produced/waste water, concentrating enzymes; sugar refining, such as separating calcium carbonate from sugar feed; critical metal extraction, such as lithium, tungsten, gold and/or silver.

The term ‘nanofiltration’ as used herein may refer to a separation technique that utilises a membrane to separate different components within a fluid mixture. The pore size of the nanofiltration membrane may be from 1 to 100 nm.

For the purpose of the present invention, an aliphatic group is a hydrocarbon moiety that may be straight chain (i.e. unbranched), branched, or cyclic and may be completely saturated, or contain one or more units of unsaturation, but which is not aromatic. The term “unsaturated” means a moiety that has one or more double and/or triple bonds. The term “aliphatic” is therefore intended to encompass alkyl, cycloalkyl, alkenyl cycloalkenyl, alkynyl or cycloalkenyl groups, and combinations thereof. The term “(hetero) aliphatic” encompasses both an aliphatic group and/or a heteroaliphatic group.

An aliphatic group is optionally a C₁₋₃₀ aliphatic group, that is, an aliphatic group with 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 carbon atoms. Optionally, an aliphatic group is a C₁₋₁₅ aliphatic, optionally a C₁₋₁₂ aliphatic, optionally a C₁₋₁₀ aliphatic, optionally a C₁₋₈ aliphatic, such as a C₁₋₆aliphatic group. Suitable aliphatic groups include linear or branched, alkyl, alkenyl and alkynyl groups, and mixtures thereof such as (cycloalkyl) alkyl groups, (cycloalkenyl) alkyl groups and (cycloalkyl) alkenyl groups.

The term “alkyl,” as used herein, refers to saturated, straight-or branched-chain hydrocarbon radicals derived by removal of a single hydrogen atom from an aliphatic moiety. An alkyl group is optionally a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Optionally, an alkyl group is a C₁₋₁₅ alkyl, optionally a C₁₋₁₂ alkyl, optionally a C₁₋₁₀ alkyl, optionally a C₁₋₈ alkyl, optionally a C₁₋₆ alkyl group. Specifically, examples of “C₁₋₂₀ alkyl group” include methyl group, ethyl group, n-propyl group, iso-propyl group, n-butyl group, iso-butyl group, sec-butyl group, tert-butyl group, sec-pentyl, iso-pentyl, n-pentyl group, neopentyl, n-hexyl group, sec-hexyl, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1,1-dimethylpropyl group, 1,2-dimethylpropyl group, 2,2-dimethylpropyl group, 1-ethylpropyl group, n-hexyl group, 1-ethyl-2-methylpropyl group, 1,1,2-trimethylpropyl group, 1-ethylbutyl group, 1-methylbutyl group, 2-methylbutyl group, 1,1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group and the like.

The term “alkenyl,” as used herein, denotes a group derived from the removal of a single hydrogen atom from a straight-or branched-chain aliphatic moiety having at least one carbon-carbon double bond. The term “alkynyl,” as used herein, refers to a group derived from the removal of a single hydrogen atom from a straight-or branched-chain aliphatic moiety having at least one carbon-carbon triple bond. Alkenyl and alkynyl groups are optionally “C₂₋₂₀ alkenyl” and “C₂₋₂₀alkynyl”, optionally “C₂₋₁₅ alkenyl” and “C₂₋₁₅ alkynyl”, optionally “C₂₋₁₂ alkenyl” and “C₂₋₁₂ alkynyl”, optionally “C₂₋₁₀ alkenyl” and “C₂₋₁₀ alkynyl”, optionally “C₂₋₈ alkenyl” and “C₂₋₈ alkynyl”, optionally “C₂₋₆ alkenyl” and “C₂₋₆ alkynyl” groups, respectively. Examples of alkenyl groups include ethenyl, propenyl, allyl, 1,3-butadienyl, butenyl, 1-methyl-2-buten-1-yl, allyl, 1,3-butadienyl and allenyl. Examples of alkynyl groups include ethynyl, 2-propynyl (propargyl) and 1-propynyl.

The terms “cycloaliphatic”, “carbocycle”, or “carbocyclic” as used herein refer to a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The terms “cycloaliphatic”, “carbocycle” or “carbocyclic” also include aliphatic rings that are fused to one or more aromatic or nonaromatic rings, such as tetrahydronaphthyl rings, where the point of attachment is on the aliphatic ring. A carbocyclic group may be polycyclic, e.g. bicyclic or tricyclic. It will be appreciated that the alicyclic group may comprise an alicyclic ring bearing one or more linking or non-linking alkyl substituents, such as —CH₂-cyclohexyl. Specifically, examples of carbocycles include cyclopropane, cyclobutane, cyclopentane, cyclohexane, bicycle[2,2,1]heptane, norborene, phenyl, cyclohexene, naphthalene, spiro[4.5]decane, cycloheptane, adamantane and cyclooctane.

A heteroaliphatic group (including heteroalkyl, heteroalkenyl and heteroalkynyl) is an aliphatic group as described above, which additionally contains one or more heteroatoms. Heteroaliphatic groups therefore optionally contain from 2 to 21 atoms, optionally from 2 to 16 atoms, optionally from 2 to 13 atoms, optionally from 2 to 11 atoms, optionally from 2 to 9 atoms, optionally from 2 to 7 atoms, wherein at least one atom is a carbon atom. Optional heteroatoms are selected from O, S, N, P and Si. When heteroaliphatic groups have two or more heteroatoms, the heteroatoms may be the same or different. Heteroaliphatic groups may be substituted or unsubstituted, branched or unbranched, cyclic or acyclic, and include saturated, unsaturated or partially unsaturated groups.

An alicyclic group is a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The term “alicyclic” encompasses cycloalkyl, cycloalkenyl and cycloalkynyl groups. It will be appreciated that the alicyclic group may comprise an alicyclic ring bearing one or more linking or non-linking alkyl substituents, such as —CH₂-cyclohexyl. Specifically, examples of the C₃₋₂₀ cycloalkyl group include cyclopropyl, cyclobutyl, cyclopentyl, cyclohexyl, cycloheptyl, adamantyl and cyclooctyl.

An aryl group or aryl ring is a monocyclic or polycyclic ring system having from 5 to 20 carbon atoms, wherein at least one ring in the system is aromatic and wherein each ring in the system contains three to twelve ring members. An aryl group is optionally a “C₆₋₁₂ aryl group” and is an aryl group constituted by 6, 7, 8, 9, 10, 11 or 12 carbon atoms and includes condensed ring groups such as monocyclic ring group, or bicyclic ring group and the like. Specifically, examples of “C₆₋₁₀ aryl group” include phenyl group, biphenyl group, indenyl group, anthracyl group, naphthyl group or azulenyl group and the like. It should be noted that condensed rings such as indan, benzofuran, phthalimide, phenanthridine and tetrahydro naphthalene are also included in the aryl group.

As used herein, unless otherwise expressly specified, all numbers such as those expressing values, ranges, amounts or percentages may be read as if prefaced by the word “about”, even if the term does not expressly appear. The term “about” when used herein means +/−10% of the stated value.

Singular encompasses plural and vice versa. For example, although reference is made herein to “a” baffle, “a” membrane, and the like, one or more of each of these and any other components can be used.

Also, any numerical range recited herein is intended to include all sub-ranges subsumed therein. Singular encompasses plural and vice versa.

As used herein, the terms “on”, “applied on/over”, “extend over”, “formed on/over” and “provided on/over” mean formed or provided on but not necessarily in contact with the surface. For example, a coating “formed over” a substrate does not preclude the presence of another coating of the same or different composition located between the formed coating and the substrate.

The terms “comprising” and “comprises” as used herein are synonymous with “including” or “containing” and are inclusive or open-ended and do not exclude additional, non-recited members, elements or method steps. Additionally, although the present invention has been described in terms of “comprising”, the invention detailed herein may also be described as “consisting essentially of” or “consisting of”.

As used herein, the term “polymer” refers to oligomers and both homopolymers and copolymers, and the prefix “poly” refers to two or more. Including, for example and like terms means including for example but not limited to.

When used herein, “average” refers to mean average, unless otherwise provided for.

Where ranges are provided in relation to a genus, each range may also apply additionally and independently to any one or more of the listed species of that genus.

All of the features contained herein may be combined with any of the above aspects in any combination.

For a better understanding of the present invention, and to show how aspects of the same may be carried into effect, reference will now be made, by way of example, to the following experimental data and figures.

### BRIEF DESCRIPTION OF DRAWINGS

FIG. 1A shows a side view of a comparative baffle (100).

FIG. 1B shows a side section view of the baffle (100) of FIG. 1A arranged within a tubular membrane (108).

FIG. 1C shows a partial cut-away side perspective view of the baffle (100) of FIG. 1A arranged within a tubular membrane (108).

FIG. 1D shows a further partial cut-away side perspective view of the baffle (100) of FIG. 1A arranged within a tubular membrane (108).

FIG. 2A shows a side view of a baffle (200) according to a first embodiment of the present invention.

FIG. 2B shows a side section view of the baffle (200) of FIG. 2A arranged in a tubular membrane (208).

FIG. 2C shows a partial cut-away side perspective view of the baffle (200) of FIG. 2A arranged within a tubular membrane (208).

FIG. 2D shows a further partial cut-away side perspective view of the baffle (200) of FIG. 2A arranged within a tubular membrane (208).

FIG. 3A shows a side view of a baffle (300) according to a second embodiment of the present invention.

FIG. 3B shows a side section view of the baffle (300) of FIG. 3A arranged within a tubular membrane (308).

FIG. 3C shows a partial cut-away side perspective view of the baffle (300) of FIG. 3A arranged within a tubular membrane (308).

FIG. 3D shows a further partial cut-away side perspective view of the baffle (300) of FIG. 3A arranged within a tubular membrane (308).

FIG. 4A shows a side section view of a baffle (400) according to a third embodiment of the present invention arranged in a tubular membrane (408).

FIG. 4B shows a side section perspective view of the baffle (400) of FIG. 4A arranged in a tubular membrane (408).

### DESCRIPTION OF EMBODIMENTS

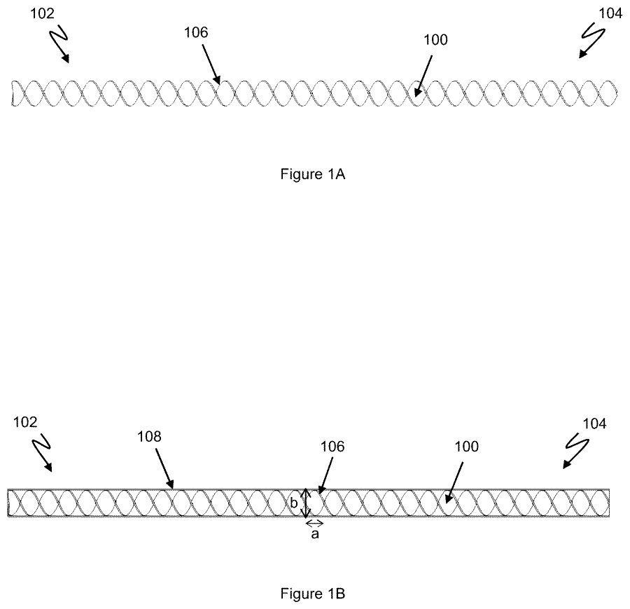

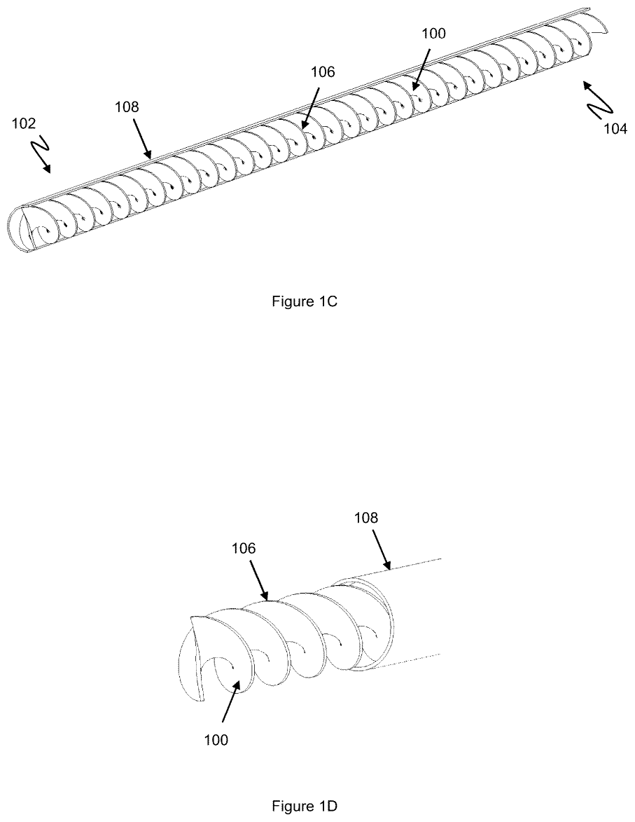

Comparative baffle (100) as shown in FIGS. 1A-D has repeating geometries (106) of the same helical shape, wherein the aspect ratio (a: b) of the geometries is constant from a proximal end of the baffle (102) to a distal end of the baffle (104).

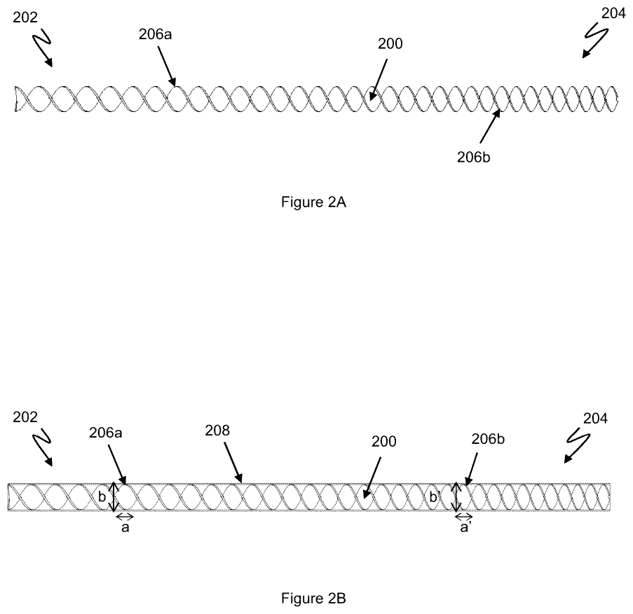

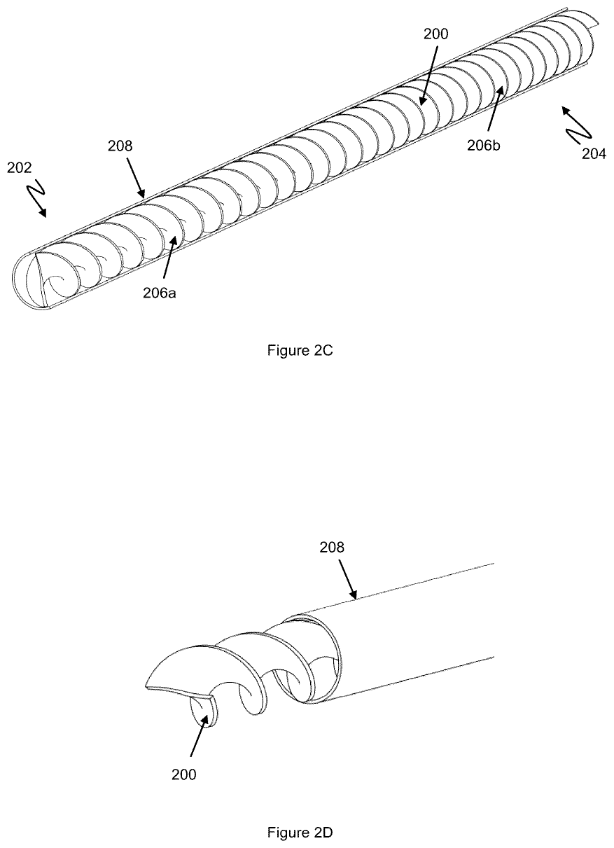

A first embodiment of a baffle (200) according to the present invention as shown in FIGS. 2A-D comprises first geometry portion (206a) and second geometry portion (206b). The first and second geometry portions each contain repeating geometry elements of substantially similar helical shape. The aspect ratio (a:b and a′:b′) at the geometry elements of the first geometry portion (206a) is higher than the aspect ratio at the geometry elements of the second geometry portion (206b) such that the aspect ratio of the baffle decreases progressively from the proximal end of the baffle (202) to the distal end of the baffle (204). Baffle (200) has an aspect ratio at the first geometry portion (206a) of 2 and an aspect ratio at the second geometry portion (206b) of 1.5.

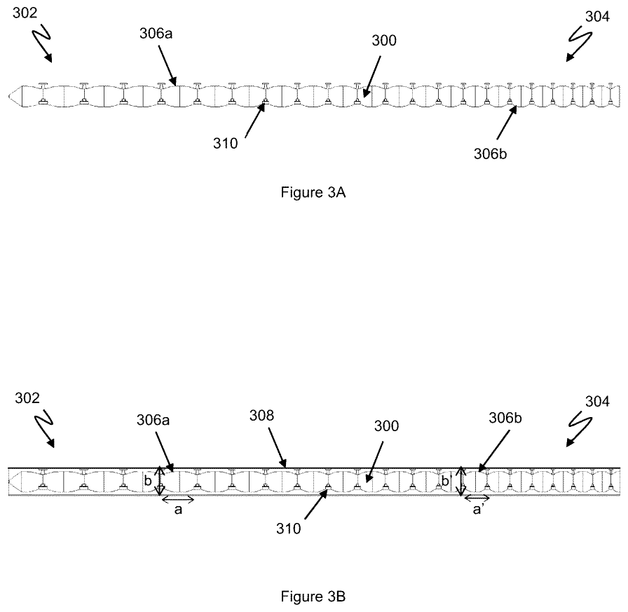

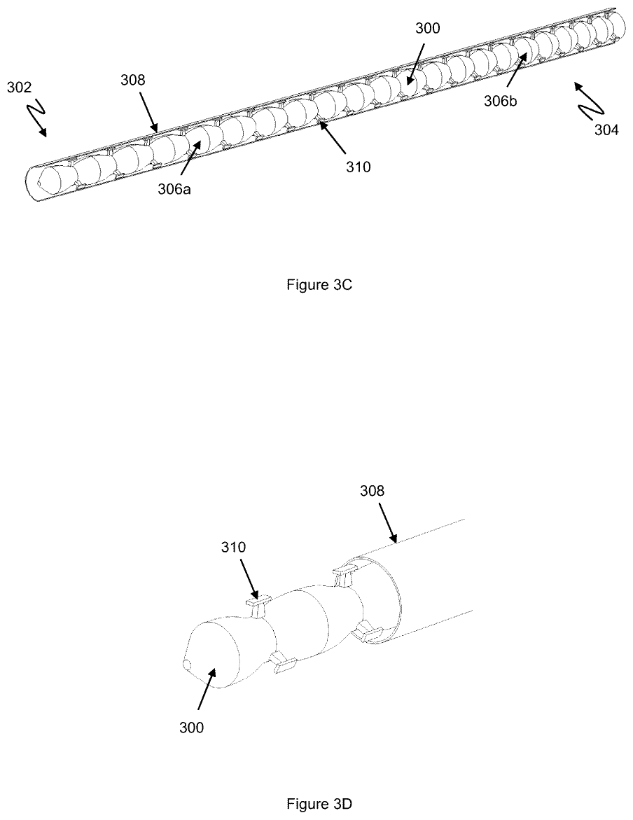

A second embodiment of a baffle (300) according to the present invention as shown in FIGS. 3A-D comprises first geometry portion (306a) and second geometry portion (306b). The first and second geometry portions each contain repeating geometry elements of substantially similar shape in the form of alternate converging and diverging contours. The aspect ratio (a:b and a′:b′) at the geometry elements of the first geometry portion (306a) is higher than the aspect ratio of the geometry elements at the second geometry portion (306b) such that the aspect ratio of the baffle decreases progressively from the proximal end of the baffle (302) to the distal end of the baffle (304). Baffle (300) further contains a series of spaced support sets (310), wherein each support set contains three radially extending supports along the same lateral plane, spaced evenly around the longitudinal axis of the baffle. The supports (310) abut the interior membrane surface when the baffle is arranged in the membrane (308) to space the geometry portions from the membrane surface.

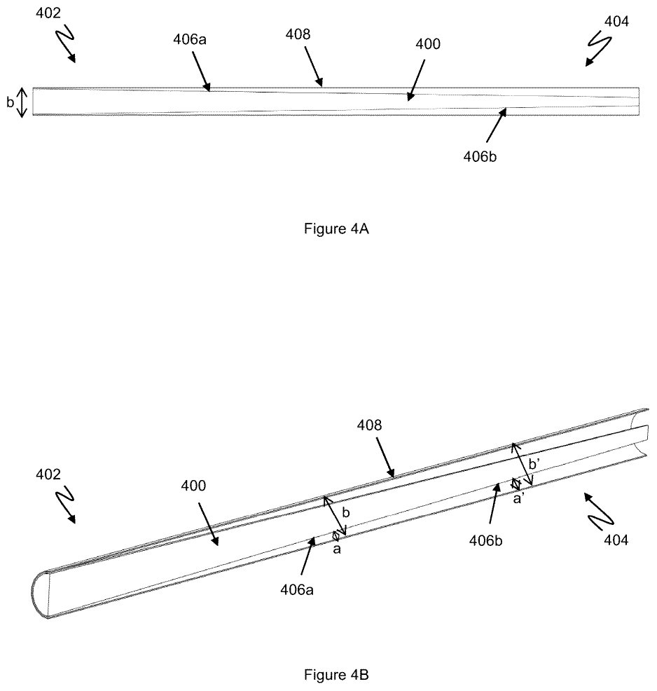

A third embodiment of a baffle (400) according to the present invention as shown in FIGS. 4A-D comprises first geometry portion (406a) and second geometry portion (406b). The first and second geometry portions each have a substantially continuously changing lateral dimension in the form of a conical geometry. The aspect ratio ((2xa):b and (2xa′):b′) at the first geometry portion (406a) is higher than the aspect ratio at the second geometry portion (406b) such that the aspect ratio of the baffle decreases consistently from the proximal end of the baffle (402) to the distal end of the baffle (404).

### EXAMPLES

### Baffle Manufacture

Comparative baffles 1 and 2, which were according to comparative baffle (100) and had constant aspect ratios of 1.3 and 1.5, respectively, as well as a baffle of the present invention according to baffle (200) were produced as follows:
Printer: Formlabs Form 3L printer
Printing method: Stereolithography (SLA)
Resin: Tough 2000 V1 (a commercially available light-sensitive thermoset resin)
Printing layer height: 100 micron

### Steps:

a) The printer was primed and the baffles printed. Once printed, the baffles were washed in a solution of Tripropylene glycol monomethyl ether (TPM) which dissolves the liquid resin on the surface of the printed baffles.
b) The excess washing liquid was wiped off the surface of the baffles and isopropyl alcohol (IPA) was then sprayed on them to further remove any residue of the liquid resin. Excess IPA was wiped away.
c) The baffles were UV-cured at 60° C. for 20 minutes. The supports were then removed and the baffles washed in water to prepare them for testing.

### Test Methods

All tests were carried out using Sterlitech cross-flow system with a Hydra-Cell diaphragm pump (max feed flow: 7.5 L/min) under 1bar TMP, 7.5L/min feed flow, at room temperature.

All tests were carried out using a microfiltration PCI LMA02 membrane housed in Micro240 (2×32 cm tubular membranes, 0.024 m² area). The feed flow comprised 1 wt % dried algae powder (Chlorella Vulgaris available from Sevenhills).

The tests were carried out according to the following procedure:
a) 250 g of dried algae powder was mixed with 5 kg of water to obtain 5 wt % algae in water. The mixture was poured into the feed tank of the cross-flow system.
b) Two PCI LMA02 tubular membranes of the same type were installed into the membrane housing. A baffle was inserted into each tubular membrane.
c) The by-pass and retentate valves were released. The pump was switched on and the rotation speed was gradually increased to maximum.
d) The by-pass value was gradually closed, followed by a gradual reduction of the retentate valve, until a transmembrane pressure (average of feed and retentate pressure) of 1 bar was reached. The pressure drop across the membrane was measured as the difference between feed and retentate pressure.
e) Permeate was collected in a beaker sitting on a balance with a data logger (with interval set to 1 min). Once 2.5 L of permeate had been collected, the concentration of the algae in the system reached 10%. At this stage, 2.5 L of feed solution with 10 wt % of algae was added to give a 5 L solution with 10 wt % algae in the feed tank. When the next 2.5 L permeate had been removed, the concentration of the algae in the feed tank reached 20 wt % at which point a further 2.5 L feed solution with 20 wt % algae was added to replenish the feed tank.

f) The total energy consumed to produce unit volume of permeate, or specific energy consumption, was obtained as the hydraulic power required over time divided by the total quantity of permeate volume removed at the end of 280 minutes.

$$SEC = \frac{\sum ( Δ P * Δ t ) * Q}{{V}_{p}}$$

### Where,

SEC=Specific Energy Consumption
ΔP=Pressure drop
Δt=Time interval
Q=Feed flow rate
Vₚ=Permeate volume collected

### Results

Test results were obtained for four different configurations as shown in the table below after running each at the operating conditions stated above for 280 minutes. As is evident from the table, the specific energy consumption was lowest for the baffle according to the present invention.

| | Specific Energy Consumption |
|---|---|
| Configuration | (W · hr/L) |
| No baffle | 12.32 |
| Comparative Baffle 1 | 11.94 |
| (with constant aspect ratio of 1.3) | |
| Comparative Baffle 2 | 11.45 |
| (with constant aspect ratio of 1.5) | |
| Inventive Baffle 1 | 9.22 |
| (varied aspect ratio of from 2 to 1.5) | |

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A baffle for a membrane device, wherein the membrane device comprises a membrane, a feed flow inlet, and a feed flow outlet, such as for water filtration,
wherein the baffle comprises a proximal end and a distal end, wherein the baffle is operable to extend along at least a portion of the membrane so that the proximal end is toward the feed flow inlet of the membrane device and the distal end is toward the feed outlet of the membrane device,
and wherein the baffle comprises a first geometry portion and a second geometry portion, wherein the first geometry portion comprises a higher aspect ratio than the second geometry portion and wherein the first geometry portion is arranged closer to the proximal end of the baffle than the second geometry portion.

2. The baffle according to claim 1, wherein the first and/or second geometry portions of the baffle independently comprise a geometry having a substantially continuously changing lateral dimension along the longitudinal length of the geometry portion and/or comprise a geometry having a varied lateral dimension along the longitudinal length of the geometry portion.

3. The baffle according to claim 2, wherein the varied lateral dimension along the longitudinal length comprises repeating geometry elements of substantially similar shape.

4. The baffle according to claim 3, wherein the geometry elements comprise helical contours and/or alternate converging and diverging contours.

5. The baffle according to claim 1, wherein the first and/or second geometry portion comprises a tapered geometry.

6. The baffle according to claim 1, wherein the first and/or second geometry portion comprises a conical geometry.

7. The baffle according to claim 1, wherein the first geometry portion comprises an aspect ratio of at least 0.2 and/or the first geometry portion comprises an aspect ratio of up to 12.

8. The baffle according to claim 1, wherein the second geometry portion comprises an aspect ratio of at least 0.05 and/or the second geometry portion comprises an aspect ratio of up to 11.

9. (canceled)

10. (canceled)

11. The baffle according to claim 1, wherein the first geometry portion comprises a geometry having a substantially continuously changing lateral dimension comprising an aspect ratio of at least 0.3 and/or up to 0.9.

12. The baffle according to claim 1, wherein the second geometry portion comprises a geometry having a substantially continuously changing lateral dimension with an aspect ratio of at least 0.1 and/or up to 0.6.

13. The baffle according to claim 1, wherein the first and second geometry portions are abutting.

14. The baffle according to claim 1, wherein the baffle comprises a spacer portion arranged between and spacing adjacent geometry portions.

15. The baffle according to claim 14, wherein the baffle comprises two sets of first and second geometry portions, each set comprising at least one first and at least one second geometry portion, wherein the geometry portion sets are separated by a spacer portion.

16. The baffle according to claim 1, wherein the baffle comprises a support operable to abut the membrane surface and space a geometry portion from the membrane surface.

17. A membrane device comprising a membrane, a feed flow inlet, a feed flow outlet, and a baffle according to claim 1, wherein the baffle extends along at least a portion of the membrane so that the proximal end is toward the feed flow inlet of the membrane device and the distal end is toward the feed outlet of the membrane device

18. (canceled)

19. The baffle according to claim 1, wherein the baffle comprises a coating arranged on the baffle.

20. (canceled)

21. The baffle according to claim 19, wherein the coating comprises a hydrophilic agent and/or a superhydrophilic agent.

22. The baffle according to claim 19, wherein the coating comprises a first coating layer comprising a hydrophilic agent and a second coating layer comprising a superhydrophilic agent.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. The membrane according to claim 17, wherein the membrane device comprises a membrane comprising a porous ceramic member, wherein the porous ceramic member comprises a first support portion operable to support a coating and further comprises a second support portion, wherein the second support portion bas a higher D75 average pore size than the D75 average pore size of the first support portion, wherein the second support portion comprises a lattice structure that has a porosity percentage of ≥10%, and wherein the porous ceramic member has a tensile strength operable to withstand feed application pressure of ≥100 kPa (1 bar).

42. (canceled)

43. (canceled)

44. (canceled)

45. (canceled)

46. (canceled)

47. (canceled)

48. (canceled)

49. A water treatment device comprising a membrane device according to claim 17.

50. (canceled)

51. The membrane device according to claim 17, wherein the membrane comprises a coating arranged on a membrane substrate.

52. The membrane device according to claim 51, wherein the coating comprises a hydrophilic agent and/or a superhydrophilic agent.

53. The membrane device according to claim 51. wherein the coating comprises a first coating layer comprising a hydrophilic agent and a second coating layer comprising a superhydrophilic agent.
